(19) United States
(12) Patent Application Publication
(10) Pub. No.: US 2006/0086675 A1
(43) Pub. Date: Apr. 27, 2006

(54) System, chamber, and method for fractionation and elutriation of fluids containing particulate components

(75) Inventor: Howard E. Purdum, Raleigh, NC (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: CryoFacets, Inc., Raleigh, NC (US)

(21) Appl. No.: 11/255,049

(22) Filed: Oct. 20, 2005

Related U.S. Application Data
(60) Provisional application No. 60/621,174, filed on Oct. 22, 2004.

(51) Int. Cl. B01D 21/26

(52) U.S. Cl. 210/787

(57) ABSTRACT

A chamber, system, and method for separating a selected component from a fluid are provided. The chamber is capable of rotating about the central axis of a centrifuge device and includes a radially-extending duct having an optimized variable cross-sectional area that decreases in relation to the outward radial distance from the central axis of the centrifuge. The optimized geometrical design of the duct provides that a centrifugal force exerted on the selected component caused by the rotation of the chamber substantially balances the drag force exerted on the selected component by the fluid as the selected component flows through the duct. Thus, the duct allows the selected component to be dispersed in equilibrium along the radial length of the duct such that the selected component may be effectively suspended with the duct and/or separated from the fluid using elutriation or other methods.

### CROSS-REFERENCE TO RELATED APPLICATION

This application claims the benefit of U.S. Provisional Application No. 60/621,174, filed Oct. 22, 2004, which is incorporated by reference herein in its entirety.

### FIELD OF THE INVENTION

The present invention relates generally to the separation and/or purification of particulate and/or cellular components of a biological fluid, such as blood, by a centrifugation process such that the components may be effectively and safely decontaminated and separated for a variety of downstream uses, including transfusion, research, and other uses. Specifically, the present invention provides a chamber and duct for elutriation having an optimized geometry for distributing a specific component within a radially-extending duct so as to more effectively separate and/or wash the specific component during a centrifugation and/or elutriation process.

### BACKGROUND OF THE INVENTION

Biological fluids, such as whole blood, may include a complex mixture of materials including, for instance, red blood cells (red cells), white blood cells (leukocytes), platelets, plasma, and various types of contaminants including pathogens. It is often desirable to separate the various components of biological solutions, such as blood, so as to enable the more effective use and decontamination of the components of the biological solution. For example, in the blood industry, whole blood must be decontaminated in order to be considered safe for transfusion to a waiting patient. Whole blood consists of various liquids and particulate and/or cellular components. The liquid portion of blood is largely made up of plasma, and the particle components may include, for instance, red blood cells (erythrocytes), white blood cells (including leukocytes), and platelets (thrombocytes). While these particulate components have similar densities, their density relationship, in order of decreasing density, is as follows: red blood cells, white blood cells, platelets, and plasma. The particulate components of whole blood are sized, in order of decreasing size, as follows: white blood cells, red blood cells, and platelets. The size and density differences of the various particulate and liquid components of whole blood are used in various fractionating methods to separate the components of whole blood from one another.

The particulate components of whole blood are often separated and/or fractionated so as to enable the more efficient use and/or decontamination of each component. In some cases, for instance, leukocytes are desirably removed or reduced in a blood unit to be transfused via a process called leukoreduction so as to decrease the chance of interaction of the leukocytes with the tissues of the transfusion recipient. When transfused to a recipient, leukocytes do not benefit the recipient. In fact, foreign leukocytes in transfused red blood cells and platelets are often not well tolerated and have been associated with some types of transfusion complications. In addition, in many cases, it is desirable to fractionate red blood cells from whole blood, and/or remove plasma from whole blood in order to safely decontaminate the blood unit. In addition, it is often also advantageous to remove platelets (thrombocytes) from a whole blood sample.

For instance, in order to use ozone (O3) decontamination techniques, on a blood unit, it is desirable to remove the lipid-containing plasma from the blood sample, as ozone may oxidize lipids, yielding highly reactive products, such as aldehydes. Some of these species, as well as ozone itself, can damage blood and other cells. Specifically, excessively oxidizing environments, such as those associated with ozone, damage red blood cells. The clinical manifestation of such damage is the formation of Heinz bodies, which are inclusions in red blood cells. The relevant laboratory test is to stain the red cells with crystal violet. The presence of Heinz bodies indicates that the cells are damaged beyond use for transfusion. In the late 1970's, however, it was discovered during atmospheric ozone studies that removal of lipids prevented the formation of Heinz bodies. Nevertheless, as late as the early 1990's claims were made that the presence of Heinz bodies counter-indicated the use of ozone for blood decontamination. In addition, the removal of plasma may also reduce and/or eliminate the possibility of transfusion-related acute lung injury (TRALI) which is caused, in part, by the presence of plasma proteins in transfused blood products.

In addition, in some cases ultraviolet C (UVC) light may be used to decontaminate blood and blood components, however, in such decontamination methods, it is necessary to remove oxygen from the blood unit prior to the application of UVC energy to the blood unit to prevent the generation of reactive oxygen species (ROS). ROS form when incident light strikes the oxygen that is dissolved in plasma or other aqueous solutions. In particular, UVC has sufficient energy to split the dissolved diatomic oxygen into two free radicals of oxygen. These radicals are so energetic that they may “burn” any proteins they encounter. The immediate degradation products are proteins that are so severely damaged that they cannot function, as well as lower energy ROS that proceed to cause even more protein damage. The type and extent of damage from ROS depends on where the ROS are formed, and what they contact. Thus, ROS formed in plasma will yield clotting proteins that can no longer cause hemostasis, immune factors that cannot attack pathogens, etc. If the ROS form near a cell, the cell membrane can be breached, allowing the contents of the cell to leak, as well as exposing the remaining cell contents to attack. Finally, ROS formation within the cell itself will result in destruction of all of the local cell contents.

According to some conventional decontamination techniques for blood, pathogen inactivation processes are utilized wherein binding agents are added to the blood sample such that the binding agents bind to the genetic material of harmful viruses, bacteria, or other pathogens within the blood sample so as to prevent their reproduction and subsequent harmful effects in the tissues of a transfusion recipient. In addition, conventional centrifugal elutriation techniques provide for nominal fractionation of blood components (such as red blood cells, white blood cells, platelets, etc.), however, such conventional techniques often lack the capability of effectively washing out, via centrifugation, plasma and/or O2 so as to allow for the safe and effective addition of other decontaminating agents and or energy (such as ozone and/or UVC energy) without the generation of Heinz bodies or other harmful effects in the remaining blood components.

For instance, in conventional centrifugal elutriation techniques, an elutriation chamber extends radially outward from a centrifuge shaft and the chamber is filled with a biological solution, such as whole blood, so as to separate the various components of the solution by their relative densities and/or sizes as the solution is subjected to the centrifugal force generated by the rotation of the elutriation chamber about the centrifuge shaft. More specifically, the goal of centrifugal elutriation is to achieve equilibrium between drag forces and centrifugal forces for each component of the solution such that the various components are fractionated into respective equilibrium layers as the elutriation chamber is rotated. However, in conventional elutriation chambers (which, in most cases, define a sharply decreasing cross-sectional area moving radially outward from the centrifuge shaft (i.e., a “cone” shape) (as shown generally in FIG. 1, herein)) the various cell components may be tightly packed within their respective equilibrium layers such that some components may be unable to reach their respective equilibrium layer through an adjacent layer of densely packed cells. Specifically, in conventional blood elutriation for any given cell size, equilibrium exists only over a quite narrow range of radial distance (relative to the central axis of the centrifuge); such that cells of a given size are relatively closely packed. As a result, it is difficult for cells of different sizes to cross opposing equilibrium layers, even if their respective density and/or size values would predictably cause these components to be separated by centrifugal force. In particular, cells of similar size (but having different mass/density) are often difficult to separate due to both close-packing and aggregation of cells (particularly for red blood cells which are similar in size to some leukocytes, but have much greater density values per unit size, on average). In addition, the close-packing induced by conventional elutriation chambers also impedes washing techniques as well as pathogen inactivation processes, in which all cell surfaces must be readily accessible in order to more effectively decontaminate and/or fractionate a blood sample. For instance, in conventional elutriation chambers, cells are close-packed within their relative equilibrium layers such that plasma components may not be adequately washed out of the blood unit by elutriating fluid that may be pumped into the elutriation chamber from the radially outward direction, thus precluding the safe use of ozone decontamination for the remaining blood components.

Thus, there exists a need for a system, chamber, and method for centrifugal elutriation of a biological solution (such as whole blood) configured to produce an equilibrium layer for a given blood component that extends over a widespread radial distance such that the cellular components suspended within the equilibrium layer may be adequately separated to allow for the effective washing of components suspended in the solution as well as to allow for ease of separation of blood components during conventional centrifugation of whole blood or other fluids. In addition, there exists a need for system, chamber, and method for centrifugal elutriation of a fluid having particulate components suspended therein that may be tailored for optimized elutriation, separation, and/or suspension of selected component sizes that may be suspended in the fluid such that specific components may be selectively fractionated from the fluid (such as, for instance, whole blood).

### SUMMARY OF THE INVENTION

The above and other needs are met by the present invention which, in one embodiment, provides a chamber and system for separating at least one component from a fluid, wherein the chamber is adapted to be capable of rotating about a central axis of a centrifuge device. The chamber includes at least one radially-extending duct defining a duct cross-sectional area oriented parallel to the central axis. Furthermore, the duct cross-sectional area is configured to decrease in relation to a radial distance from the central axis such that the centrifugal force exerted on the at least one component by the chamber rotating about the central axis of the centrifuge device substantially opposes a drag force exerted on the at least one component by the fluid along the length of the duct.

According to some aspects of the present invention, the system and chamber may further define a radially-extending duct wherein the duct further comprises an upper wall extending radially outward from the central axis of the centrifuge and a lower wall extending radially outward from the central axis of the centrifuge. Furthermore, the upper wall and the lower wall may be formed so as to converge about a plane of rotation defined by a radius extending radially outward from the central axis by such that the duct cross-sectional area is configured to decrease in relation to the radial distance from the central axis. Furthermore, in some embodiments having convergent upper and lower walls, the duct may extend radially outward 360 degrees about the central axis while still defining a duct cross-sectional area that decreases in relation to a radial distance from the central axis. Thus, the 360 degree duct may not only provide for a greater overall duct volume, and eliminate the need for side walls, but the 360 degree duct may still provide a duct geometry configured such that the centrifugal force exerted on the at least one component by the chamber rotating about the central axis of the centrifuge device substantially opposes a drag force exerted on the at least one component by the fluid along the length of the duct.

Some embodiments of the present invention may further provide a chamber, and a duct defined therein, for uniformly distributing a plurality of components having a corresponding plurality of sizes, including a minimum size and a maximum size. According to some such embodiments, the duct may further comprise an entrance, defining an entrance area (and/or entrance height) between the upper and lower walls, disposed at a first radial distance from the central axis. The entrance geometry may be configured such that a centrifugal force exerted on a component having the maximum size substantially opposes a drag force exerted on the component having the maximum size at the first radial distance, such that the component having the maximum size is suspended at a radial periphery of the duct. The duct may also comprise an exit, defining an exit area (and/or exit height) between the upper and lower walls, disposed at a second radial distance from the central axis. The exit geometry may be configured such that a centrifugal force exerted on a component having the minimum size substantially opposes a drag force exerted on the component having the minimum size at the second radial distance, such that the component having the minimum size is suspended at a radially-inward extent of the duct length. Furthermore, the convergent area profile formed by the upper wall and the lower wall may be further configured and/or optimized such that the plurality of components having sizes between the minimum and maximum size exhibit a substantially uniform distribution between the first and second radial distances. According to some embodiments, the substantially uniform distribution may be more specifically defined as a substantially uniform number of the plurality of components per a unit volume of the duct between the first and second radial distances. In order to attain a relatively optimum convergent profile for uniformly distributing a plurality of components having a corresponding plurality of sizes, the convergent profile (defining a convergent flow area) formed between the upper and lower duct walls may be configured to converge such that substantially uniform number of the plurality of components per a unit volume of the duct may be suspended between the first and second radial distances.

According to other aspects of the present invention, the system and chamber may further comprise one or more convergent vanes extending radially inward through the duct such that the overall duct cross-sectional area decreases in relation to the radial distance from the central axis. Furthermore, in other embodiments of the system and chamber the duct may further comprise an elutriation inlet and outlet located near the radially outer and inner edges of the duct, respectively, so as to allow for the passage of a supply of elutriation fluid through the duct. In such embodiments, the elutriation fluid may be passed through one or more flow-straightening devices which may include, for instance, multiple orifices, baffles, mesh screens, and combinations thereof.

Another aspect of the present invention provides a method for separating at least one component from a fluid. The method may first comprise providing a radially-extending chamber defining a duct adapted to be rotated about a central axis of a centrifuge device. The chamber provided may define a duct cross-sectional area oriented parallel to the central axis wherein the duct cross-sectional area may be configured to decrease in relation to a radial distance from the central axis. Some method embodiments may further comprise rotating the radially extending chamber, the fluid, and the at least one component disposed therein about a chamber about the central axis of the centrifuge device such that a centrifugal force exerted on the at least one component of the fluid by the chamber rotating about the central axis of the centrifuge device substantially opposes a drag force exerted on the at least one component by the fluid along a length of the duct. Some method embodiments of the present invention may further comprise optimizing a radially-extending duct contour for at least one component having a minimum component size and a maximum component size such that a centrifugal force exerted on the at least one component of the fluid by the chamber rotating about the central axis of the centrifuge device substantially opposes a drag force exerted on the at least one component by the fluid along a length of the duct.

According to other advantageous aspects of the present invention, the method may further comprise the steps of: directing a supply of elutriation fluid radially inward through the duct in a substantially uniform radial flow so as to wash contaminants out of the fluid and away from the at least one component; passing the supply of elutriation fluid through a flow-straightening device; filtering the contaminants from the elutriation fluid using a filter device disposed radially inward from the duct; and collecting the elutriation fluid and the contaminants in a collection reservoir in fluid communication with an elutriation outlet defined in an inner radial wall of the duct.

Embodiments of the present invention may advantageously provide a system, chamber, and method whereby the at least one component separated from the fluid is spread uniformly through the radial length of the duct. Thus, instead of providing a radially-narrow packed equilibrium zone, as is common in conventional elutriation chambers, the embodiments of the chamber and system of the present invention provide a duct wherein the components are spaced far apart radially within the duct. Thus, according to advantageous aspects of the present invention, components of different sizes may pass readily through the duct so as to provide increased separation of the at least one component from the fluid and/or other components suspended in the fluid. In addition, the liquid in which the at least one component is initially disposed may be displaced easily by a supply of elutriation fluid so as to enable more thorough washing of the at least one component.

Such embodiments provide significant advantages as described and otherwise discussed herein.

### BRIEF DESCRIPTION OF THE DRAWINGS

Having thus described the invention in general terms, reference will now be made to the accompanying drawings, which are not necessarily drawn to scale, and wherein:

FIG. 1A shows a top view of an example of a conventional elutriation rotor according to the prior art as well as the various forces exerted on a component suspended in a biological solution that is subjected to an elutriation process;

FIG. 1B shows a side view of an example of a conventional elutriation rotor according to the prior art as well as the various forces exerted on a component suspended in a biological solution that is subjected to an elutriation process;

FIG. 2 shows a top view of a chamber and duct for separating at least one component from a fluid according to one embodiment of the present invention;

FIG. 3 shows a top view schematic of a duct for separating at least one component from a fluid according to one embodiment of the present invention;

FIG. 4 shows a top view of a chamber and duct for separating at least one component from a fluid wherein the duct includes vanes for decreasing the duct cross-sectional area in the radially-outward direction;

FIG. 5 shows a top view of a chamber and duct according to one embodiment of the present invention wherein the duct includes widened vanes and braking and filter areas for retaining cells in the duct during elutriation processes;

FIG. 6 shows a top view and corresponding radial view of a chamber and duct according to one embodiment of the present invention wherein the chamber and duct define a substantially circular cross-sectional shape;

FIG. 7A shows a top view of a chamber and duct according to one embodiment of the present invention wherein the side walls diverge in the radially outward direction and wherein the top and bottom walls converge in the radially outward direction such that the duct cross-sectional area exhibits an overall decrease in the radially-outward direction;

FIG. 7B shows a side view of a chamber and duct according to one embodiment of the present invention wherein the side walls diverge in the radially outward direction and wherein the top and bottom walls converge in the radially outward direction such that the duct cross-sectional area exhibits an overall decrease in the radially-outward direction;

FIG. 8A shows a plot of a chamber contour defined by upper and lower walls converging in the radially outward direction such that the duct cross-sectional area exhibits an overall decrease in the radially-outward direction, wherein the chamber contour is optimized to suspend particles having a diameter of between about 2 and 4 microns; and

FIG. 8B shows a plot of a chamber contour defined by upper and lower walls converging in the radially outward direction such that the duct cross-sectional area exhibits an overall decrease in the radially-outward direction, wherein the chamber contour is optimized to suspend particles having a diameter of between about 6 and 9 microns.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

While the embodiments of the system, chamber, and method for elutriating biological fluids containing particulate components including, for instance, whole blood, are described below in the context of the fractionation and washing of whole blood components including plasma, platelets, red blood cells (erythrocytes), white blood cells (leukocytes), platelets (thrombocytes) and other blood components, it should be understood that the embodiments of the present invention may also be utilized to fractionate and/or elutriate components within a variety of fluids such that the components are separated from and/or fractionated within the fluid such that an elutriating fluid may be passed through the components to effectively wash the components so as to eliminate unwanted contaminants that may be present either within the fluid suspension or adhered to the components themselves. Further, the fractionated and/or washed components produced by embodiments of the present system may be processed in downstream and/or concurrent processing steps that may include, but are not limited to: decontamination by UVC emissions, and decontamination by ozone exposure. Furthermore, the processed, fractionated, and/or washed components may then be used in a variety of applications, including, for instance, research uses, transfusion applications, and other uses described more fully herein.

Furthermore, because embodiments of the present invention may act to radially separate cellular components along the radial length of the duct, embodiments of the present invention may also be used as cell culture chambers. For example, because the cellular components of fluids introduced into the duct may be effectively radially spaced within the duct, the cellular components may be less likely to aggregate into “clumps” and thus an increased surface area of the cellular components may be exposed to a flow of nutrient material which may be introduced via the inlets of the present invention. Furthermore, the embodiments of the present invention may also be useful for cell culture in that waste products emitted by the cultured cells may be more effectively washed out of the suspended cell colony since the cellular components may be more radially-distributed within the duct. Furthermore, individual cells cultured in a suspended environment such as that provided by the chamber 200 and ducts 210 of the present invention, may be more easily manipulated by micropipette techniques and/or microfluidics methods than cells cultivated in a packed bed or in cellular aggregations.

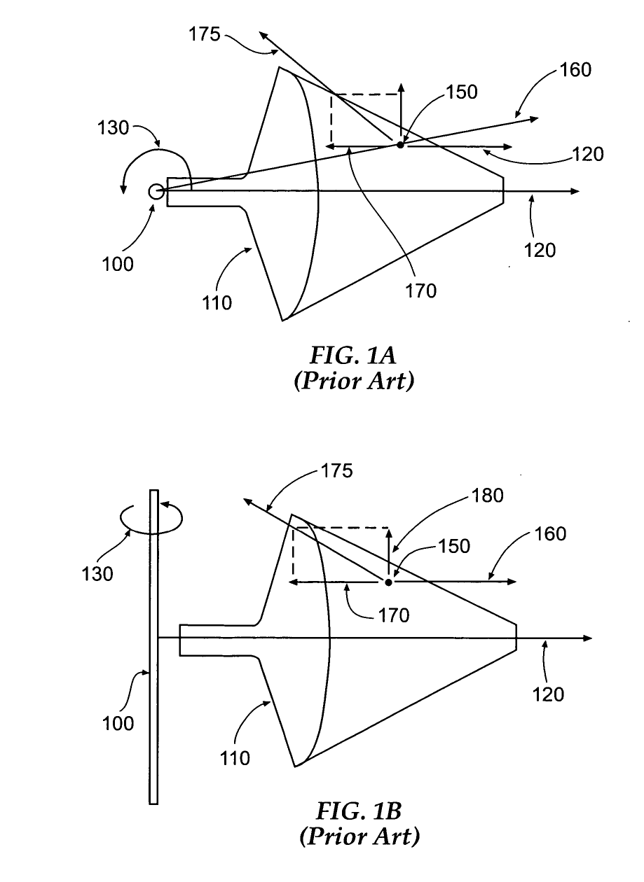

FIGS. 1A and 1B show top and side views, respectively, of a conventional “expanding cone” elutriation rotor as disclosed in the prior art including an elutriation chamber 110 filled with a fluid (such as whole blood) having particles 150 (such as blood cells, including red blood cells, white blood cells, platelets, and other blood particulates) suspended therein. As the elutriation chamber 110 is rotated about a central axis 100 (such as the central axis of a centrifuge device), a centrifugal force 160 is generated that acts on the particle 150 in the radially-outward direction 120. One skilled in the art will appreciate that the centrifugal force 160 generated by the rotation of the chamber 110 is dependent upon the rotational velocity 130 of the chamber about the central axis 110 according to the following relationship.
F_{c}=(mₚ−m_{f})Rω² (1)
Wherein mₚ is the mass of the particle 150, m_{f} is the mass of the fluid, R is the distance in the radially-outward direction 120 of the particle 150 from the central axis 120, and ω is the rotational velocity of the particle about the central axis 100.

In addition, as shown in FIG. 1A, a drag force 170 is exerted on the particle 150 by the fluid in which it is suspended as the particle 150 (propelled by the centrifugal force 160 generated according to Equation 1) proceeds with a linear velocity in the radially-outward direction 120. One skilled in the art will appreciate that the drag force 170 exerted on a particle 150 progressing through a fluid with a given velocity may be expressed using the following relationship.
F_{d}=6πr ƒv (2)
Wherein r is the radius of the particle 150 (making the simplifying assumption that the particle 150 is spherical in shape), η is the viscosity value of the fluid, and v is the linear velocity of the particle 150 as it proceeds in the radially-outward direction 120 through the fluid.

When the centrifugal force 160 is equivalent to the drag force 170 as outlined by the relationships in equations (1) and (2), one skilled in the art will appreciate that the particle 150 proceeds in the radially-outward direction 120 at terminal velocity, wherein terminal velocity may be expressed according to the following relationship.

$${v}_{term} = \frac{k Δ ρ {d}^{2}}{18 η} R {ω}^{2} \qquad ( 3 )$$

Wherein Δρ is the difference in density of the fluid and the particle 150, and wherein k is a correction factor to account for non-spherical particles (such as biconcave red blood cells, for example).

Furthermore, as one skilled in the art will further appreciate, the fluid flow velocity at any point within the chamber 110 varies according to the following relationship,
dm/dt=ρAv (4)
wherein v is the fluid flow velocity, dm/dt is the mass per unit time of fluid flowing though a given point in the chamber 110, ρ is the density of the fluid, and A is the cross-sectional area of the chamber 110 at the same given radial point. Thus, the overall velocity of the flow of fluid in the radially outward direction 120 in a chamber 110 generally slows as the cross-sectional area of the chamber 110 widens (as given in equation (4)).

Thus, as defined by equation (4), the terminal velocity of a suspended particle 150 varies linearly with the cross-sectional area of the chamber 110 such that the drag force 170 also varies linearly with the cross-sectional area of the chamber 110. In addition, as defined in equation (1), the centrifugal force 160 exerted on the particle 150 varies with the distance in the radially-outward direction 120 from the central axis 100 of the centrifuge. The chamber design actually used in conventional elutriation systems is shown in FIG. 1A (top view) and in FIG. 1B (side view). Such conventional chambers have “expanding cone” geometries. As shown in FIG. 1B, the immediate result is that the advancing particles 150 above and below the plane of rotation 120 now have a z-component of force 180 parallel to the rotation axis 100. As a consequence, there exists only point in the “expanding cone” geometry wherein the resultant drag force 175 (which includes both z-axis components 180 and radially-inward components 170) exactly matches the centrifugal force 160. Specifically, this point is on the central chamber axis 120, at the single point where the radially-inward drag force 170 exactly matches the centrifugal force 160. Thus, in conventional chamber designs, it is difficult to maintain a wide-ranging force equilibrium in the radial direction 120 for the particles 150 suspended therein.

Another consequence of the z-component 180 of force is the transition zones (defined by slightly unbalanced resultant drag 175 and centrifugal forces 160) include the space above and below the central chamber axis 120 (see FIG. 1B). It is essential to note, however, that these transition zones are not the same strength. Instead, the transition zones are stronger in the angular direction than in the z-direction 180. The basis for this difference can be seen by comparing FIGS. 1A and 1B, which show the top and side views of the conventional chamber. Specifically, in FIG. 1B the centrifugal force 160 is shown acting radially outward from an elevated point along the axis of rotation, parallel to the chamber axis. Conversely, in FIG. 1A the centrifugal force 160 in the plane of rotation has a significant component that is not parallel to the chamber axis 120. The transition zone is therefore extended in the radial directions.

The transition zone is also strongly influenced by the flow of the fluid through the chamber 200 body. As one skilled in the art will appreciate, ideal plug flows expand along a conical section, with sections normal to the central axis 100. Unfortunately, the advancing plug flow encounters uniform centrifugal force 160 only along the vertical z-axis 100, while the flow in the plane of rotation encounters a variable centrifugal force 160 profile. In particular, at the points farthest from the central axis 100, there is a significant gap between the ideal plug shape and the locus of constant centrifugal force 160 magnitudes in the plane of rotation. Compared to the slice centers, the slice boundaries thus experience higher forces, which again extend the transition zones wherein drag 170 and centrifugal 160 forces may become unbalanced.

Finally, the fluid and particles 150 in the chamber 200 are also subject to two other forces: inertia and Coriolis. The inertial forces are greatest during startup, rotor speed changes during operation, and shutdown. However, if these forces change the flow fields, their results can be of consequence during even during steady state operation. For example, as one skilled in the art will appreciate, shifting a packed bed of cells during changes in rotor speed may produce a channel that will persistently maintain a penetrating jet flow.

Like centrifugal force, Coriolis force is a consequence of rotating systems. Most commonly cited as the reason that hurricanes and other low pressure disturbances circle counter-clockwise in the northern hemisphere, Coriolis forces are also widely cited as the reason for many flow irregularities in elutriation systems. The fundamental principle here is that the flowing fluid moves essentially along a radius vector, which by definition is perpendicular to the angular motion vector. The resulting vector cross product yields a Coriolis force out of the plane of rotation, parallel to the z-axis.

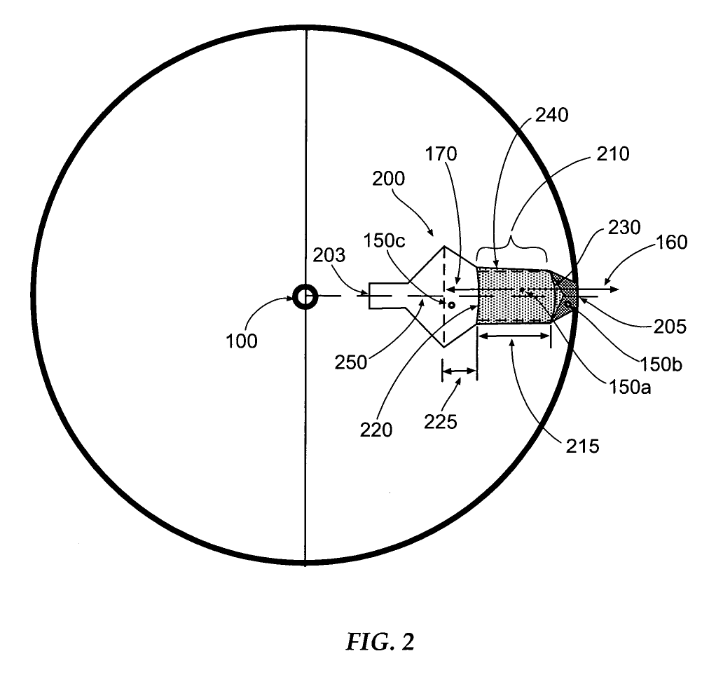

In order to more completely balance the centrifugal force 160 and drag force 170 exerted on a given particle 150 within a chamber 110, embodiments of the present invention provide a system and chamber for elutriating biological fluids containing at least one particulate component 150 wherein the cross-sectional area of the chamber 110 is narrowed gradually in the radially-outward direction 120 according to the centrifugal force 160 relationship defined by equation (1) such that at each radial point within a duct 210 (see FIG. 2) disposed within the chamber 200, the centrifugal force is substantially balanced against the drag force (in the substantially radial direction) such that each particle 150 proceeds at a velocity approximating terminal velocity from an inner radial wall 220 of the duct 210 to an outer radial wall 230 of the duct 210 (as described in more detail below with regard to FIG. 2). As described below, however, a supply of elutriation fluid may be supplied through an elutriation inlet 205 (disposed radially outward from the duct 210) in a fluid flow field advancing at or near the terminal velocity of the at least one component 150 such that in some elutriation processes, selected components 150 may be suspended in radially-separated equilibrium along the radial length 215 of the duct 210 wherein the advancing elutriation flow field acts to more completely wash and/or decontaminate the selected components 150 suspended therein. Other components (other than the selected components 150, for which the duct 210 geometry is optimized) will either settle radially outward in the duct (due to their higher terminal velocities) or be washed radially inward by the elutriating fluid (due to their lower terminal velocities).

Thus, according to embodiments of the present invention, a duct 210 is provided within the chamber 200 wherein along the radial distance defined by the duct 210, the centrifugal force 160 and drag force 170 exerted on a collection of selected particles 150 are substantially balanced in the radial direction 120 such that the selected particles 150 are more effectively radially separated along the radial distance 215 defined by the duct 210. Thus, as the particles 150 proceed (at terminal velocity, in embodiments wherein an elutriating flow is not introduced) toward the outer radial wall 230 of the duct 210, a supply of elutriating fluid may be introduced from an inlet defined in the outer radial wall 230 to more effectively wash and/or suspend the particles 150 as described in more detail below. In addition, the chamber 200 and duct 210 of the present invention act to prevent the formation of close-packed equilibrium layers within the duct 210 that may preclude the passage of more dense components 150 radially outward through the duct 210 via the application of a centrifugal force 160.

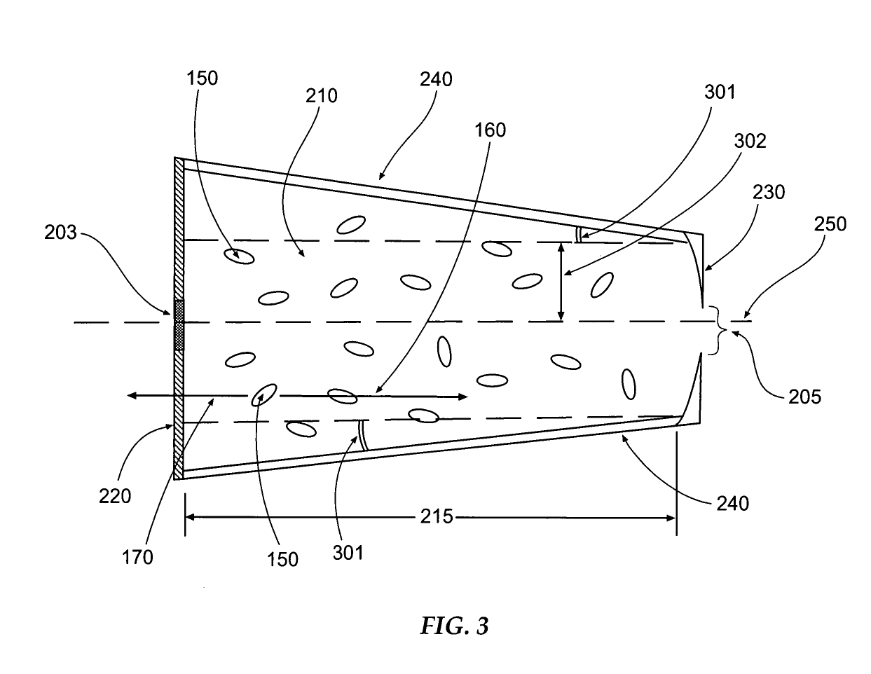

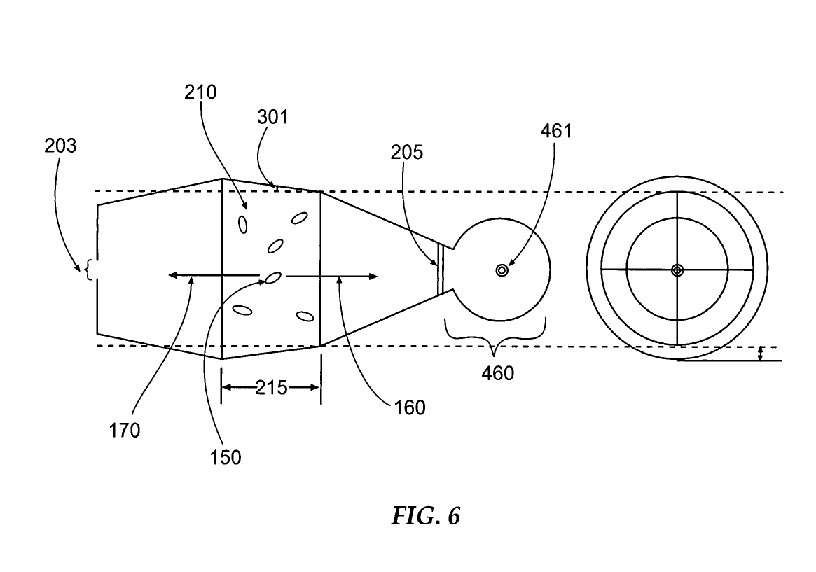

FIG. 2 shows a system and chamber 200 for separating at least one component 150 from a fluid according to one embodiment of the present invention wherein the chamber 200 is adapted to be capable of rotating about a central axis 100 of a centrifuge device 400. The chamber 200 comprises at least one radially-extending duct 210 defining a duct cross-sectional area oriented parallel to the central axis 100. In addition, the duct 210 cross-sectional area is configured to decrease in relation to the radial distance 215 from the central axis 100 such that a centrifugal force 160 exerted on the at least one component 150 of the fluid substantially opposes a drag force 170 exerted on the at least one component 150 by the fluid along the radial length 215 of the duct 210 (see also FIG. 3). As described more fully below, the duct 210 may comprise side walls 240 and/or upper and lower walls such that the radial cross-section of the duct 210 is substantially rectangular in shape. In other embodiments, however, the duct 210 may define a circular, oval, or polygonal radial cross-section having a radial cross-sectional area that is configured to decrease in relation to an increase in the radial distance from the central axis 100 such that a centrifugal force 160 exerted on the at least one component 150 of the fluid substantially opposes a drag force 170 exerted on the at least one component 150 by the fluid along the radial length 215 of the duct 210 (see generally, FIG. 6, illustrating one embodiment of the chamber 200 and duct 210 having a substantially circular cross-sectional area).

According to some embodiments, and as shown generally in FIG. 3, the duct 210 comprises a pair of side walls 240 that may be offset 302 from a radius defining the radial center 250 of the duct 210. Furthermore, the pair of side walls 240 may be oriented at an angle 301 relative to a line that is substantially parallel to the radial center 250 of the duct 210 such that the cross-sectional area encompassed by the duct 210 decreases in the radially-outward direction along the radial length 215 of the duct 210. According to some embodiments, the angle 301 of orientation of the side walls 240 (relative to a line parallel to the radial center 250 of the duct 210) may be adjusted so as to ensure that components 150 of a selected density, and/or geometry may reach equilibrium within the radial length 215 of the duct 210 such that the components 150 are substantially suspended within the radial length 215 of the duct 210.

For a variety of reasons, which are known to those skilled in the art, modern centrifuge devices are limited to a radius from the central axis 100 of a few tens of centimeters at most. As such, the radial centrifugal vector (i.e., the centrifugal force vector 160 over an elutriation chamber 200 of useful size must span several degrees about the central axis 100. Thus, while the centrifugal force 160 along the radial center line 250 of the chamber 200 (and/or duct 210) may be balanced readily, the angular components of the vectors to each chamber 200 side wall become progressively more difficult to match for wide elutriation chambers (such as the conventional chamber 110 shown generally in FIG. 1), resulting in compression of the components 150 along the chamber 200 walls. Another problem faced in widely-diverging conventional elutriation chambers is the eventual separation of fluid flow from the chamber wall, even with the use of screens and other flow-straightening devices (which have much more effect in reducing flow separation in gently-divergent ducts 210, such as those disclosed herein).

Thus, given the limitations of both force vector balance and separation, the duct 210, according to various embodiments of the present invention comprises side walls 240 having an angle 301 of at most 15 degrees and in some embodiments having an angle 301 no greater than seven (7) degrees (relative to a line parallel to the radial center 250 of the duct 210). Restricting the angle 301 of the side walls 240 of the duct 210 also restricts the volume of fluid that may be processed in a given duct 210. No particular angle 301 may be completely optimal for producing a radially-spaced equilibrium zone for all components 150, all centrifuge devices 400, and/or all fluid volumes. Thus, instead of the “one size fits all” of conventional elutriation chambers 110 (see FIG. 1), the present invention provides a duct 210 and/or surrounding chamber 200 having various optimized geometrical parameters for individual components 150 that may be present in a fluid such as whole blood.

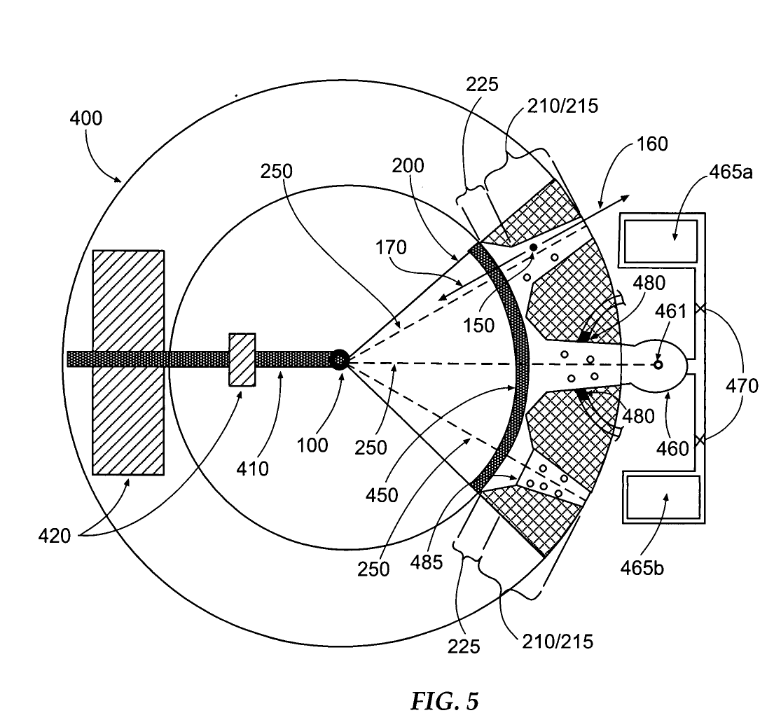

The duct 210, chamber 200, and system of the present invention provides optimized side wall 240 angles 301 for a variety of components 150 such as cellular components of whole blood. Furthermore, in some embodiments, the present invention provides a duct 210 having multiple radial sectors separated by vanes 310 so as to provide a sufficient processing volume to fractionate and/or elutriate a fluid sample containing the components 150 of interest. For example, platelet products from a given single donation from an individual amount to only several milliliters. In this case, a single chamber 200 and duct 210 ( having an angle 301, of for example, 7 degrees) at a radial distance from the central axis 100 (25 cm) is more than adequate to reduce the leukocytes via elutriation through the duct 210 (see, for instance, FIG. 2). Conversely, the red blood cells from the same donation comprise at least 100 ml. In this case, a single duct 210 located radially outward from the central axis 100 at 25 cm simply does not suffice to process this volume. Instead, a duct 210 having multiple radial sectors (separated by vanes 310) may be required, such that each radial sector has the maximum angle 301 of 7 degrees (as shown generally in FIG. 5).

In some embodiments, the angle 301 of orientation of the side walls is less than about 7 degrees relative to a line that is substantially parallel to the radial center 250 of the duct 210. In other embodiments of the present invention, the angle 301 of orientation of the side walls less than about 15 degrees, less than about 10 degrees, or less than about 5 degrees relative to a line that is substantially parallel to the radial center 250 of the duct 210 so as to provide reductions in area suitable for producing equilibrium within the radial length 215 of the duct 210 for a selected component 150.

In addition, the duct 210 may further comprise an inner radial wall 220 proximal to the central axis 100 and an outer radial wall 230 disposed substantially parallel to and radially outward from the inner radial wall 220. Finally, in order to form a fully-enclosed structure, the duct 210 may further comprise an upper wall disposed substantially perpendicular to the central axis 100 and a lower wall disposed substantially perpendicular to the central axis and below the upper wall.

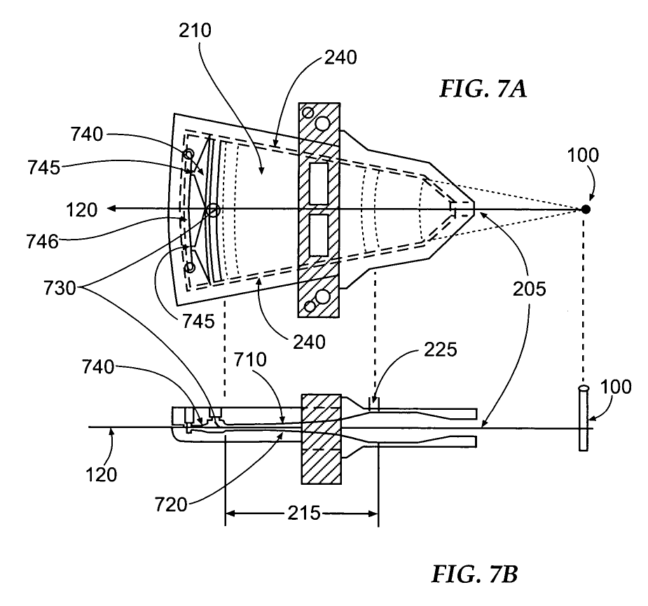

According to some additional embodiments (shown generally in FIGS. 7A and 7B), the upper 710 and lower walls 720 of the duct 210 may be formed so as to converge about a plane of rotation defined a radius 120 extending radially outward from the central axis 100 by such that the duct 210 cross-sectional area may be configured to decrease in relation to the radial distance (i.e., over the radial length 215, of the duct 210) from the central axis 100. As described above, with regards to FIGS. 1A and 1B, a major problem in conventional chambers 110 is the off-radial force component. The only way to avoid this problem is to avoid angular dependence. The resulting overall chamber shape must therefore be essentially a pie wedge (See FIG. 7A, showing one embodiment of the present invention from a top view), pointing towards the axis 100. One skilled in the art will appreciate that such a shape provides separation even for conventional centrifugation. Because conventional elutriation and/or separation chambers (shown generally in FIGS. 1A and 1B) consist of a wedge pointing in the wrong (radially-outward, for example) direction for eliminating the off-radial force components, embodiments of the present invention having convergent upper 710 and lower 720 walls may show even greater improvement over conventional chambers. In addition, it should be understood that the wedge-shaped duct 210 shown in FIG. 7A may be necessary only to fit in the space allowed in existing centrifuge rotors. System embodiments of the present invention may provide centrifuge devices 400 capable of accommodating an “expanded” duct 210 that may fill a full circle (360 degrees) about the axis of rotation 100, thereby greatly increasing the separation and/or elutriation volume within the duct 210, while also eliminating the need for the two sealed side walls 240. The side view shown in FIG. 7B of the convergent upper and lower walls 710, 720 represents one example of a cross-section of a “full circle” chamber having a duct 210 defining a cross-sectional area that decreases in relation to the radial distance (i.e., over the radial length 215, of the duct 210) from the central axis 100.

As one skilled in the art will appreciate, conventional elutriation chambers 110 (see FIGS. 1A and 1B) are based on “packed” or “saturated” particle 150 beds, with all of the problems previously noted. The alternative presented by embodiments of the present invention is to “suspend” the particle 150 beds along the radial length 215 of the duct 210, so that the cells essentially float freely. To achieve this most desirable condition, note that the centrifugal force depends on the radial distance by F_{c}=m Rω², as above. Note also that the flow velocity v of a fluid of density ρ through a pipe of cross sectional area A is simply dm/dt=ρAv, where dm/dt is the mass flow rate per unit time. Therefore, since the drag depends on the velocity, as described earlier, all that is necessary for the particles 150 to be in equilibrium (fixed at a given radial distance) at all times is to vary the cross sectional area to match the respective forces. Thus, because the centrifugal force 160 decreases towards the axis, the duct 210 cross-sectional area must increase. Because a pie wedge shape is ideal for eliminating off-axis centrifugal forces 160 (see FIG. 1A, showing a top view of a conventional chamber) and other off-axis forces, the duct 210 cross section must increase in area (in the radially-inward direction) parallel to the rotation axis 100 (i.e., vertically (note the vertical expansion and lateral contraction of the duct 210 shown in FIGS. 7A and 7B)). For example, if the inlet 730 to the duct 210 is 1 cm high at a distance 10 cm from the axis of rotation 100, the exit (defined by the radially-inner extent of the radial length 215 of the duct 210) of the duct 210 must be 4 cm high at a distance 5 cm from the axis 100: a factor of 2 to maintain the same area, times another factor of 2 to account for cutting the centrifugal force in half at this distance. Under this arrangement, the particles 150 may be uniformly distributed between the 5 and 10 cm distances, and stay fixed (suspended) at their respective locations as the elutriation fluid flows past them.

It will be appreciated by one skilled in the art that such an ideal suspension holds only for particles 150 of a specific size, and in practice, biological cells of even the same type can vary significantly in size. For example, useful platelets range from 2 to 4 microns in diameter. Because the settling velocity depends upon the square of the diameter, as shown above, the respective stream velocities thus vary by a factor of four. Therefore, using the above flow relation, the increase in area must be a factor of four. Including the area increase required to compensate for centrifugal force 160, the exit height for the above example thus becomes 16 cm. Under this arrangement, the 2 micron platelets will be suspended at the exit (5 cm from the central axis 100), and the 4 micron platelets will be suspended at the inlet (10 cm from the central axis 100). Platelets of intermediate sizes will be located between these two end points. All of these cells will remain suspended at these respective radial distances in the flowing elutriation fluid.

This ability to hold only the selected cells in a selected location in a free floating distribution provides the means of overcoming many of the problem areas described above for blood cell processing, as well as the problems that limit conventional elutriation systems. The crucial factor here is that the selected cells are sufficiently far apart that applied elutriation fluid has full access to each selected cell, while larger and smaller cells rapidly pass out of the system. The net result is rapid, thorough washing and leukoreduction of the cells, along with rapid and thorough addition and removal of any reagents needed for decontamination, gas treatment, storage, etc. Furthermore, this radial, floating distribution is inherently not subject to pellet formation, jetting, or any of the other flow irregularities described above for conventional chambers. Furthermore, because the components 150 may be effectively distributed by size, the chamber may define collection outlets at one or more points along the length 215 of the duct 210 such that components having a selected size may be effectively collected via the collection outlets. According to some other embodiments, the chamber may also define collection outlets at one or more of the braking zones 225 defined near the radially-inward extend of the duct 210 such that components having a selected size may be effectively collected via the collection outlets.

In some embodiments, as shown generally in FIGS. 7A and 7B a collection outlet 745 may be defined radially outward from the inlet 730 and/or duct 210 entrance (for introducing elutriation fluid to the duct 210). The duct inlet 730 may be used to introduce elutriation fluid in a similar manner to the bulb inlet 460 described herein with respect to FIG. 6. The collection outlet 745 may be used to systematically collect particles 150 having a maximum size (such as monocytes being separated from whole blood) that may congregate at the radial periphery of the duct 210). The collection outlet 745 may be defined radially outward from a constricting zone 740 configured to slow the radially outward advance of the particles (which may advance at a terminal velocity into the constricting zone 740. Furthermore, a collection channel 746 may be defined in the radial periphery of the chamber for introducing a flow of collection fluid that may be pumped at a velocity that is sufficiently great to clear the channel 746 before the entering particles reach the radial periphery of the channel 746. The use of a collection channel having such a continuous collection flow may thus prevent the clogging of the collection outlet 745. This process is also aided by the optimal geometry of the duct 210 of the present invention, which ensures that the particles 150 are distributed relatively evenly (per unit volume) throughout the length 215 of the duct 210. Thus, according to most embodiments of the present invention, it will be unlikely that a “packed bed” of particles will form at the radial periphery, which may block and/or impede the collection of particles at a radial collection outlet 740 such as that shown in FIGS. 7A and 7B.

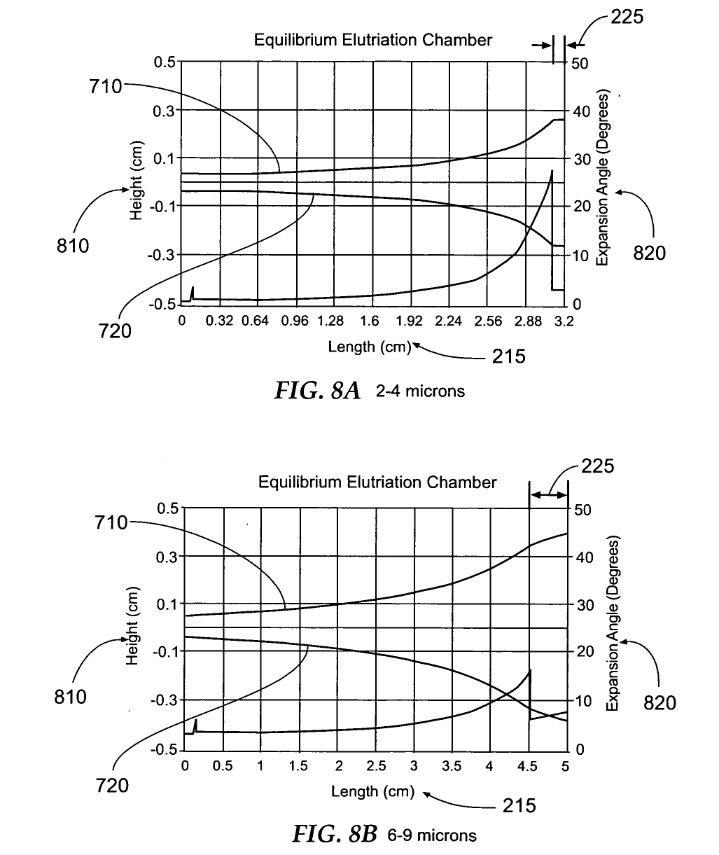

The shape of the convergent profile of the upper and lower walls 710, 720 shown generally in FIG. 7B may be optimized for a given range of particle 150 sizes. For example, a starting maximum particle 150 size may be specified at a specified radial distance. The chamber inlet height and angular width may then be specified, from which the starting duct 210 area may be calculated. Next, the radial length 215 of the duct 210 may be specified, from which the necessary ending width follows as above from the restriction of decreasing centrifugal force 160 in the radially-inward direction. Next, the minimum particle 150 size may be specified, allowing the duct 210 outlet cross-sectional area to be increased appropriately. As a first approximation, the convergence contour of the upper and lower walls 710, 720 of the duct 210 may assumed to vary linearly or according to the power law (in the range of 3.5 to 4.5, for example). The length 215 of the duct 210 may then be broken into equal steps, and the particle distribution may be calculated while satisfying the centrifugal force 160 (see Equation (1), above) and drag equations (see Equation (2), above) point by point. The resulting particle 150 number density may not be constant, so the difference from the average density is taken and used to correct the convergence contour. This process is then repeated until a uniform particle number density is found, typically requiring 5 to 7 iterations. The output of such iterations may be used to generate a duct 210 profile in actual size, along with profile data that may be directly used by Computer Numeric Control (CNC) machining equipment to generate duct 210 prototypes. Furthermore, the duct 210 profile may be further refined in response to experimental data so as to achieve an optimal distribution of particles per unit volume of the duct 210 between along the duct length 215. Some exemplary results for selected particle 150 size ranges are shown in FIGS. 8A and 8B.

The starting point for defining the convergence contour described above may comprise the definition of the ratio of the maximum to minimum particle size for a plurality of particles of interest (for example, red blood cells may have a size ratio of about 1.14 (8 microns to 7 microns, for example). This information, along with the determination of the geometry of the particular centrifuge and/or centrifuge rotor being used may then determine the entrance and/or exit areas or heights (i.e., the distance between the upper wall 710 and lower wall 720 at the radial extents of the duct length 215). While the entrance and exit areas and/or heights may vary along with duct length 215 depending on the geometry of the particular centrifuge rotor used to rotate the duct 210, the ratio of effective particle sizes may be specified for a particular particle type. For example, for platelets, which have a size distribution (diameter, for example) of 2 to 4 microns, the ratio maximum particle size to minimum particle size may be specified as being between about 1.5 and 3 to 1, or more preferably, between about 1.75 and 2.5 to 1, and most preferably, between about 2.1 and 2.25 to 1. Such a ratio may provide a geometry that effectively collects and/or suspends platelets within the duct length 215, however such a size ratio may also serve to collect and/or suspend a plurality of particles having a similar size (diameter) distribution and ratio of maximum to minimum size particle. For example, monocytes (having a size distribution of 10 to about 20 microns) may utilize the same size ratio as platelets. In another example, a size ratio for red blood cells (having a maximum size (diameter) of about 8 microns and a minimum size (diameter) of about 7 microns), may be specified as being between about 1 and 1.5 to 1, more preferably about 1-1.3 to 1, and most preferably between about 1.05 and 1.1 to 1. Thus, according to various embodiments of the present invention, ducts 210 may be provided to collect and/or suspend very specific groups of component 150 sizes and/or types.

FIG. 8B shows the expansion zone necessary to retain particles 150 from a base unit size up to 50% greater than the base unit size (such as, for example., 6 to 9 microns). As described above, such a value may be selected to span the normal size range of red blood cells (which may have a size range of 7 to 8 microns in some cases). Incidentally, the biconcave shape of red blood cells results in a significantly lower effective cross section because the cells tend to align with the flow; the chamber design profile design (shown in FIG. 8B) thus covers all such ranges. In FIG. 8B, the chamber contour axis 810 is on the left, corresponding to the symmetric duct 210 defined by the upper and lower walls 710, 720. The vertical expansion angle 820 axis is on the right and the curve is along the bottom; note that this angle can readily exceed the earlier cited 7 degree limit because the side walls 240 are contracting along the “pie wedge” shape shown generally from above in FIG. 7A. The chamber 200 also includes a band of constant size at each end for stability, i.e., there is a constant size zone (i.e., a “braking zone” 225) at each end of the duct 210 to ensure that the largest and smallest particles 150 are not lost due to variations in pump speed, RPM, etc. Such “braking zones” 225 may define collection outlets in the upper and or lower walls 710, 720 for collecting components 150 of interest. FIG. 8A shows a duct 210 optimized for suspending particle 150 sizes between 2 and 4 microns (such as platelets).

The chamber 200 and duct 210 may be constructed of a variety of engineering materials suitable for the rotational stresses and speeds encountered in centrifugation processes. For instance, the chamber 200 and/or duct 210 may be composed of metals, alloys, engineering polymers (such as LEXAN, for example), or other materials suitable for centrifugation applications. In addition, in some embodiments, the chamber 200 and/or duct 210 of the present invention may be composed of a UVC-transparent material, such as, for instance, fused quartz or other varieties of UVC-transparent polymers such that UVC radiation may be applied directly to the fluid and components 150 thereof as they are being subjected to centrifugation, separation, and/or elutriation within the chamber 200 and/or duct 210 as described more particularly below. In addition, in some embodiments, wherein the duct 210 comprises side walls 240, an inner radial wall 220, an outer radial wall 230, and upper and lower walls (710, 720, see FIGS. 7A, 7B) to form a fully-enclosed structure, the duct 210 components and/or walls 240, 220, 230, etc. may be composed of PTFE or another non-stick and/or washable polymer that may be easily washed, sterilized, and/or replaced by a disposable replacement such that specific disposable (and/or easily cleaned) ducts 210 may be easily replenished within the chamber 200 for centrifugation, separation, and/or elutriation of components 150 having a specific size, shape, and/or cross section suitable for a selected component 150a (as described more fully below). In addition, in some embodiments, the duct 210 may further comprise a PTFE chamber liner to provide a sterile disposable liner for the duct 210. Thus, according to some system embodiments of the present invention, a general centrifuge device 400 may be provided that may be alternatively fitted with various chambers 200 and/or ducts 210 having geometrical configurations (include side wall 240 angles 301) suitable for fractionating and/or elutriating a selected component 150 from a fluid sample.

As shown generally in FIG. 2, the chamber 200 of the present invention may be used to separate a selected component 150a from a fluid. For instance, in some cases it is desirable to fractionate whole blood into cellular components 150a of a certain size, shape, and/or density. According to one example, embodiments of the chamber 200 and duct 210 of the present invention may be used to separate and treat some distribution of spherical components 150a, such as leukocytes that are present in either a whole blood sample or in a fluid containing unwanted contaminants and/or particles having a size, density and/or shape that varies from the leukocyte (such as, in this example, heavier cells 150a (including red blood cells) and lighter, smaller components 150c (including platelets and small contaminants). Leukocytes vary in size from about 5 microns up to about 30 microns, consisting of overlapping types. According to one embodiment of the duct 210 of the present invention, the 12 micron size of leukocyte may be targeted for fractionation as the selected component 150a. Because of previously cited technical problems, a conventional elutriation system (see generally, FIG. 1) would inadvertently include a relatively broad range of cells, depending on the skill of the operator, and the component distribution in the sample. As discussed above, the underlying problem in conventional elutriation chambers is that the target components 150a are either in the packed bed 140 (see FIG. 1) (created by the non-radially distributed equilibrium zone of conventional elutriation chambers), or they are strongly flushed out the elutriation outlet 203 (see FIG. 3); any neighboring cells and/or components 150 suffer the same fate.

Conversely, as shown in FIG. 3, chamber 200 and duct 210 embodiments of the present invention provide a stable equilibrium zone along the radial length 215 of the duct 210 for only (in this example) the 12 micron selected component 150 distribution. By balancing the centrifugal force 160 and the drag force 170 vectors for the selected component (using for instance equations (2) and (4) shown above), only the 12 micron selected components 150a (see FIG. 2) are suspended in stable equilibrium radially inward from a radially-outward packed bed containing the larger components 150a. Furthermore, only the 12 micron selected components 150a are not flushed away with the supply of elutriation fluid that may be supplied from the elutriation inlet 205 and expelled out of the elutriation outlet 205 located radially inward from the chamber 200. Thus, within the radial length 215 of the duct 210 substantially all of the 12 micron selected components 150 (and only a nominal amount of other components) are suspended as the centrifugal force 160 matches the drag force 170 of the supply of elutriation fluid flowing past the fixed selected components 150a. Note that if the supply of elutriation fluid was to be halted, the selected components 150a may move towards the radially-outward end of the duct 210, at, for instance, terminal velocity).

The angle 310 of orientation of the side walls of the duct 210, according to various embodiments of the present invention, may be tailored for a specific selected component 150a. For example, assuming a duct 210 is positioned such that its outer radial wall 230 is a radial distance of 25 cm from the central axis 100. Within the duct 210, at a radial distance of 20 cm, however, the centrifugal force is 20/25 of the peripheral force (see equation (1). For this reason, the flow area at 20 cm radial distance must be 25/20 of the peripheral area to match the peripheral drag. Under this arrangement, all particles of 12 micron diameter will be suspended in a fixed location in the 5 cm long duct having a duct cross-sectional area that increases by 125% from the outer radial wall 230 (at 25 cm) to the inner radial wall 220 (at 20 cm). One skilled in the art will appreciate that there exist minor angular force components, minor flow fluctuations, and other flow variations within the duct, but the overall effect is that the presence of an optimized duct 210 provides for the radial separation of components 150 within the duct which allows for improved elutriation, washing, and other processing. In addition, in some cases, a slight increase in elutriation fluid velocity (flowing radially inward from the elutriation inlet 205, for instance) may allow the duct 210 to provide equilibrium for only a slightly larger component 150 size, thereby providing some flexibility for a given duct 210 geometry that may be optimized for a particular cell or component 150 size.

Other embodiments of the duct 210, chamber 200, and system of the present invention may be optimized for selected components 150a of different sizes and flattened geometries. For example, red blood cells are relatively dense components 150 having diameters of approximately 7-8 microns and a biconcave shape. FIG. 5 shows a system having a duct 210 divided by vanes 310 into radial sectors so as to provide sufficient volume for processing the large volume typically occupied by a blood sample containing red blood cells. The radially-outward end of the sectors of the duct 210 has a reduced area such that the largest red blood cells, arranged with the radially-inward flowing supply of elutriation fluid may be held at equilibrium at this radial point. Conversely, the smallest red cells, arranged normal to the flow of elutriation fluid, will be stationary at the radial end of the duct 210 closest to the central axis 100. All intermediate red blood cells, and at all intermediate orientations, may thus be held at equilibrium between these two extremes along the radial length 215 of the duct 210. In this embodiment, all of the red blood cells may thus remain suspended in equilibrium within the radial length 215 of the duct 210 during processing. Additionally, all plasma, small leukocytes, and platelets, may be washed out of an elutriation outlet 203 (see generally FIG. 2) that may be defined in a radially-inward wall of the chamber 200). Conversely, all large leukocytes may be thrown (via large centrifugal force generated in part by the relatively large mass of the largest leukocytes) to the outermost radial point of the centrifuge (which may be, in some embodiments, a bulb inlet 460 as described in more detail below with respect to FIG. 5). Only the very few leukocytes that have sufficiently large diameters to overcome precisely their lower density may fail to be separated from the widely dispersed red blood cells held within the radial length 215 of the duct 210, but such leukocytes may be inactivated in a subsequent UVC treatment or other subsequent leukoreduction processing step. Thus, according to the various embodiments of the present invention, the area ratio between the inner radial wall 220 and the outer radial wall 230 of the duct 210 may thus be determined based on the range of cross-sectional sizes that may be exhibited by the selected components 150 that are sought to be held within the radial length 215 of the duct 210.

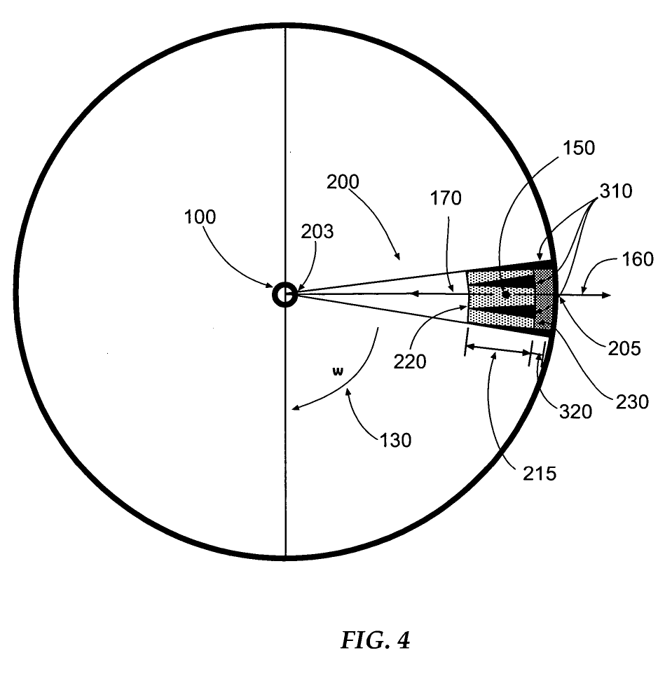

As shown generally in FIG. 2, embodiments of the present invention may also be used for elutriating a fluid containing one or more particulate components 150 by injecting a supply of elutriating fluid (such as saline containing a variety of additives that may be suitable for the washing operation and/or elutriation of whole blood) through an elutriation inlet 205 defined, for instance, in the outer radial wall 230 of the duct 210. For instance, according to some embodiments, the outer radial wall 230 of the duct 210 defines at least one elutriation inlet 205, wherein the at least one inlet 205 is configured to allow fluid communication between the duct 210 and a supply of elutriating fluid. The elutriation inlet 205 may be further configured to direct the supply of elutriating fluid radially inward through the duct 210 in a substantially uniform radial flow so as to effectively balance and/or counteract the centrifugal force 160 generated by the rotation of the chamber 200 about the central axis 100 of the centrifuge device. As shown in FIG. 4, the elutriation inlet 205 may also further comprise a distributor device 320 which may be used to ensure uniform elutriation inlet 205 velocities (that are directed substantially in the radially inward direction (directly opposing the centrifugal force 160 vector generated by centrifugation). The distributor device 320 may further comprise a plate defining multiple orifices, mesh screens, baffles, vents, and/or other flow-straightening devices similar to those disclosed below. The distributor device 320 disposed at the elutriation inlet 205 may thus prevent Coriolis jetting and other problems of conventional geometries. In addition, this arrangement also initiates and maintains plug flow, thereby further enhancing the elutriation process.

The elutriation inlet 205 may be in fluid communication with a variable-speed fluid pump or other device suitable for selectively directing the supply of and altering the velocity of elutriating fluid into the radially-outward end of the duct 210. The elutriating fluid may be forced through the selected components 150a which may be held in equilibrium within the duct and due to the radial separation of the selected components 150a along the radial length 215 of the duct 210. Thus, the elutriating fluid may more effectively reach and wash all surfaces of the selected components as the elutriating fluid passes radially-inward through the duct 210.

The ability of the system to suspend the selected components 150a with minor or no contact between adjacent selected components 150a may provide an opportunity to wash the selected components 150 thoroughly and rapidly with a variety of elutriating fluids. The elutriating fluid utilized in the present invention may comprise saline solution, as described generally above, as well as other additives suitable for the elutriation process at hand. For instance, in whole blood elutriation processes, the elutriating fluid may be used to maintain the viability of the components 150 (red blood cells, for instance) being elutriated. For this reason, sugars or other nutrients may be added to the elutriating fluid. Likewise, salts may be added to maintain proper osmotic pressure balances between the cells and the surrounding fluids.

In addition, in some instances, various chemical decontamination agents may be added to an elutriating fluid used in blood component 150 decontamination, such as aldehydes. Photo chemicals may also be added for later light exposure. Ozone may also be added, notably in solution form to blood components 150 in order to eliminate possibly harmful pathogens. In this case, the components 150 (such as red blood cells, leukocytes, and/or platelets) suspended in the duct 210 may be washed first (with, for instance pure saline elutriating fluid) to remove plasma component of the whole blood; otherwise, toxic lipid degradation products will form due to the interaction of ozone with lipids found in blood plasma. Specifically, in whole blood processes, red blood cells will develop Heinz bodies if plasma is not adequately washed out of the duct 210 prior to the addition of an ozone-containing elutriating fluid. For ozone treatment applications, the ozone-containing elutriating fluid may be pumped in conventionally (i.e., through the elutriating inlet 205), provided in a bag on the rotor, or generated from water or oxygen on the rotor via an integrated electrochemical cell. In the case of water generation of ozone on the rotor, the output from the electrochemical cell must be mixed with salt to maintain proper osmotic pressures.

Another option is to wash the components 150 (blood cells, for instance) in degassed elutriating fluid, or elutriating fluid saturated in gasses other than oxygen. In either embodiment, the net result is that the cells will be surrounded by an oxygen poor environment, and thus quickly lose their intracellular oxygen as well. Over time, even the residual oxygen in the cells will be consumed during normal metabolism, or even chemically accelerated metabolism due to the addition of extra sugars, etc. The result is that the oxygen poor cells and surrounding fluid may then be irradiated by UVC or higher energy photons without generating oxygen free radicals or other reactive oxygen species in the elutriated product. The geometry of the duct 210 of the present invention mat allow the cells to be sufficiently radially dispersed within the duct 210 such that they may be sufficiently degassed for the safe downstream use of UVC radiation for decontamination and/or leukoreduction purposes.

According to other blood fractionation and/or elutriation processes other additives can also be used in the elutriating fluid including, for instance, agents configured to invoke an immune response, as may be necessary as part of vaccine production. Agents may also be added to the elutriating fluid for treatment of patients in the case of transfusion. For example, in the case of degassed cells, it is preferable to re-introduce oxygen slowly to limit ischemia/reperfusion damage. Beyond protecting the cells, these agents could also be quite useful to limit damage to cardiac, lung or other tissues.

The chamber 200 and duct 210 of the present invention may also be used to fractionate and more effectively elutriate blood components 150 that have been in storage prior to their infusion into a patient. For instance, there is some indication that gasses such as nitric oxide may also be of use in preventing cardiac damage. In this case, the gasses would be introduced in a post-storage elutriation process to ensure adequate, uniform dosage. This post-storage elutriation may also eliminate the possibility of transfusion-related acute lung injury (TRALI) from the plasma proteins formed during storage. The radial dispersion of the blood components 150 within the duct 210 may better ensure that potentially dangerous pathogens, contaminants, or other undesirable components may be adequately washed from the duct 210 (and from the selected blood components 150 suspended therein) as the supply of elutriating fluid is forced through the elutriation inlet 203, through the duct 203, and out of the chamber 200 through an elutriation outlet 203 (as described below).

In some embodiments, the duct 210 may further comprise an elutriation outlet 203 defined by the inner radial wall 220 of the duct 210. In some instances, as shown generally in FIG. 2, the elutriation outlet 203 may be disposed radially inward from the duct 210 and defined, for instance in a wall of the chamber 200. The elutriation outlet 203 may, in some instances, be configured to allow fluid communication between the duct 210 and a collection receptacle (not shown) suitable for collecting the elutriation fluid and/or any contaminants or other elutriates that may be washed out of the fluid and/or the components 150a, 150b, 150c suspended therein. As is the case with the elutriation inlet 203, the elutriation outlet 205 may also be further configured to direct the supply of elutriating fluid radially through the duct 210 in a substantially uniform radial flow. For instance, both the elutriation inlet 203 and elutriation outlet 205 may further comprise at least one device configured to direct the supply of elutriating fluid radially inward through the duct in a substantially uniform radial flow. According to the various embodiments of the present invention, such devices (sometimes referred to as flow straighteners) may include multiple orifices, baffles, screens, and/or combinations thereof. In embodiments of the present invention using flow straightening screens, the screens may comprise thin mesh sheets placed at expansion points and along the elutriation path (i.e., the radial path from the elutriation inlet 205 to the elutriation outlet 203) to prevent the separation of the fluid flow from the side walls 240 of the duct 210 (and/or the walls of the entire chamber 200) and to better encourage plug flow through the chamber 200 and duct 210. In addition, in some embodiments, flow straightening screens may be used that include a thicker mesh density disposed near the radial center line 250 in order to more effectively encourage fluid flow along the side walls 240 of the duct 210 and/or the walls of the chamber 200.

Flow straightening devices (such as screens, multiple orifices, baffles, etc.) may be disposed at various points along the radial inner and outer walls 220, 230 of the duct 210, along the innermost and/or outermost radial ends of the chamber 200 (i.e., in the elutriating inlet 205 and elutriating outlet 203 shown generally in FIGS. 2 and 3), and/or radially inward of a component braking zone 225 defined in the chamber 200 (as described in more detail below and shown in FIG. 5 as a flow straightening screen 485). In addition, according to the various embodiments of the present invention, combinations of these devices may be placed in transition zones of the chamber 200 wherein “transition zone” is defined generally as a radial point within the chamber 200 wherein the cross-sectional area of the chamber 200 exhibits a drastic change (i.e., areas of the chamber 200 outside of the gradual area taper of the duct 210 (such as, for instance, in the transition from the duct 210 to a component braking zone 225 disposed radially inward from the duct 210 (as shown generally in both FIGS. 2 and 5). In addition flow straightening and/or distributing devices may be disposed within the elutriation inlet 205 so as to provide a distributed flow of elutriation fluid as the supply of elutriation fluid enters the duct 210 from the outer radial wall 230. This distribution zone may thus help to avoid blockages as large dense cells may be forced radially outward during centrifugation and block a narrow, non-distributed elutriation inlet 205.

Furthermore, a “lifting zone” may also be defined just radially inward from the outer radial wall 230 of the duct 210. Such a “lifting zone” may be useful in cases wherein, for example, platelets are contaminated with leukocytes and wherein the have a size range from about 2 to 30 microns. This may require an area ratio (from the radial inner wall 220 of the duct 210 to the outer radial wall 230) of 900/4=225, which is impractical given the radius constraints of modern centrifuge devices. Instead, note that it is only necessary to achieve equilibrium for the platelets, which extend from 2 to 4 microns, for an area ratio of 16/4=4. Under this arrangement, the leukocytes can be held in a “lifting zone” between the inlet and the exit. Ideal balance does not need to be maintained in this zone, but only in the following equilibrium zone. For this reason, the lifting zone can consist of a widely diverging conical or rectangular section. To distribute the flow and damp any chugging (the periodic blocking and subsequent sudden intake, by large components 150 exiting the chamber 200 via the elutriation inlet 205) or other instabilities, the lifting zone can be filled with baffles, multiple screens, fiber plugs, suitable for lifting and/or better distributing heavier, larger, and/or denser components 150 as they are propelled to the radially outer edges of the chamber 200.

Additionally, the inner radial wall 220 may define the outer radial edge of a radially-inward exit zone from the duct 210 that leads radially-inward to the chamber 200 which, in some embodiments, comprises a gentle inward taper (as shown generally in FIG. 4 and FIG. 5). As in FIG. 5, the exit zone may be, in some cases, preceded by a component braking zone 225 (discussed in detail below) disposed radially-inward from the duct 210 as shown in FIGS. 2 and 5. The gradual inward taper of the exit zone defined by the chamber 200 (as in FIG. 4) may thus help to avoid flow separation at the point where the chamber 200 area changes from expanding (i.e., radially inward along the radial length 215 of the duct 210) to contracting (i.e., radially-inward from the radial inner wall 220 of the duct.) Such a gradually tapering exit zone may aid in maintaining flow at the walls of the chamber 200 radially inward from the duct 210 and thus aids in maintaining uniform fluid flow within the radial length 215 of the duct 210.

According to the various embodiments of the present invention, the elutriation inlet 203, the elutriation outlet 205, and/or the various apertures defined by the flow straightening devices described above may be sized to retain and/or filter a variety of components 150 within the duct 210. In some cases, wherein the chamber 200 and duct 210 are used to fractionate and/or elutriate components 150 from whole blood, the cellular components 150 (such as red blood cells, leukocytes, and/or platelets) exist in whole blood over a variety of sizes. For example, platelets range in diameter from about 2 to about 4 microns. In addition, cellular blood components 150 are not spherical: platelets are flattened, and red blood cells are biconcave. Thus, to account for these size factors, the elutriation inlet 205 aperture diameter may be sized to retain the largest cells (i.e., leukocytes), aligned with the flow. Furthermore, the elutriation outlet 203 aperture diameter may be sized to account for the smallest cells (i.e., platelets), aligned normal to the flow. In a like manner, the apertures defined by various flow straightening devices disclosed generally above may also be sized to exclude from and/or retain selected components 150 within the chamber 200 and/or duct 210. For instance, in some blood elutriation embodiments (as shown for instance in FIG. 2), apertures defined in the radial inner and outer wall 220, 230 may be sized such that the duct 210 may retain cellular blood components 150 that have been introduced into the duct 210 of all selected sizes, in all possible orientations relative to the radial direction 120 (see FIG. 1, generally).

In other embodiments, as shown generally in FIGS. 2 and 5, the chamber 200 of the present invention may further define a component braking zone 225 within the chamber radially inward from the duct 210. The component braking zone 225 may be defined by, in some instances, a pair of side walls flaring outward from a line that is substantially parallel to the radial center line 250 of the duct 210 such that the cross-sectional area encompassed by the component braking zone 225 is greatly increased from the innermost radial end of the duct 210. As described above in relation to equation (4) the overall velocity of the flow of fluid in the chamber 200 generally slows as the cross-sectional area of the chamber 200 (or duct 210) widens. The component braking zone 225 defined, for instance, at the innermost radial end of the duct 210 may prevent accidental wash-out of the components 150 suspended therein as elutriation fluid is forced through the duct 210 from the elutriation inlet 203 to the elutriation outlet 205. One skilled in the art will appreciate that such a component braking zone 225 may provide stability to the duct 210, chamber 200, and system of the present invention during start-up (i.e., the initial flow of elutriating fluid) and prior to the collection of selected components 150a (see FIG. 2). As shown in FIGS. 7B, 8A, and 8B a component braking zone 225 may also be defined by a gradual increase in cross sectional area defined by upper and lower walls 710, 720 near the radially inward extents of the duct 210, such that particles 150 of a relatively constant size and/or diameter may be suspended within the braking zone 225.

FIG. 4 shows an alternate embodiment of the chamber 200 and duct 210 of the present invention wherein the at least one duct 210 further comprises at least one vane 310 extending radially inward from the outer radial wall 230 to the inner radial wall 220, and wherein the vanes define a vane cross-sectional area oriented parallel to the central axis 100. The vane cross-sectional area is configured to increase in relation to a radial distance from the central axis 100 such that the overall duct 210 cross-sectional area decreases in relation to the radial distance outward from the central axis 100 (as in the embodiment shown in FIG. 2, for instance) and such that the at least one vane 310 defines at least two radial sectors within the duct 310. More particularly, the vane 310 cross-sectional area is configured to increase (either linearly, or according to other higher order relationships) in relation to the radial distance from the central axis 100 such that the sides of the vane 310 are oriented at a vane angle from a radius extending from the central axis. Furthermore, the vane 310 may be further configured such that the vane angle increases from the inner radial wall 220 to the outer radial wall 230 of the duct 210. According to various embodiments of the present invention, the vane angle may have various angular values suitable for reducing the overall cross-sectional area of the duct 210 in the radially outward direction, including, for instance less than about 15 degrees, less than about 10 degrees, less than about 5 degrees, and/or other angular values suitable for substantially balancing the centrifugal force 160 and the drag force 170 exerted on a component 150 suspended radially within the duct 210 as it is rotated about the central axis 100.

In addition, the vanes 310 not only provide more physical separation between components 150 suspended in the duct 210, but they also act to increase the uniformity of fluid flow through the duct by more effectively guiding elutriating fluid from the elutriation inlet 205 to the elutriation outlet 203. In the embodiment shown in FIG. 4, the vanes 310 also counteract the overall widening of the cross-sectional area of the chamber 200 in the radially-outward direction so as to better maintain a force balance between the drag force 170 and the centrifugal force 160 that is exerted on the components 150 suspended in equilibrium within the duct. More particularly, the vanes 310 are configured to align a greater portion of a drag force 170 vector in a direction that is substantially opposite the centrifugal force 160 (which acts purely in the radially outward direction). In addition, the decreasing vane 310 cross sectional area (in the radially inward direction) ensures that the overall duct cross-sectional area decreases in the radially outward direction (gradually, as described above with respect to FIG. 3) so as to provide a radially-distributed zone of equilibrium wherein the components 150 of the fluid undergoing centrifugation steadily advance toward the extreme outer radial boundary of the duct 210 at terminal velocity (in cases where no radially-inward flow of elutriation fluid is supplied).

To ensure that the above equilibrium condition exists in three-dimensions, the duct 210 shown in FIG. 4 is shaped as a cylindrical sector (i.e., the top and bottom walls are oriented perpendicularly to the central axis 100 about which the chamber 200 and duct 210 are rotated. Furthermore, in some embodiments, the vanes 310 define at least one channel, wherein the at least one channel is configured to allow fluid communication between the at least two radial sectors such that fluid (and components 150) suspended therein may flow laterally from one radial sector of the duct 210 to a neighboring radial sector. The channels in defined in the vanes 310 improve equilibrium between neighboring radial sectors. This may be desirable in cases wherein one radial sector is over-filled with components 150, while a neighboring radial sector is nearly free of components 150. Such channels, however, may not be desirable in embodiments used in decontamination applications due to their tendency to interrupt and/or disrupt the flow of a supply of elutriation fluid that may be introduced from a radially-outward elutriation inlet 205.

FIG. 5 shows another embodiment of the present invention providing a system for separating at least one component 150 from a fluid, wherein the system comprises a centrifuge device 400 having a central axis 100 as well as a chamber 200 adapted to rotate about the central axis 100 of the centrifuge device 400. As in the chamber 200 embodiments of the present invention discussed above, the chamber 200 comprises at least one radially-extending duct 210 defining a duct cross-sectional area oriented parallel to the central axis 100, and wherein the duct cross-sectional area is configured to decrease in relation to a radial distance from the central axis 100 such that a centrifugal force 160 exerted on the at least one component 150 of the fluid by the chamber 200 rotating about the central axis 100 of the centrifuge device 400 substantially opposes a drag force 170 exerted on the at least one component 150 by the fluid along the radial length 215 of the duct 210.

The system shown in FIG. 5 also includes a duct 210 defining a cylindrical sector having at least two central vanes 310 extending radially inward from the outer radial wall 230 to the inner radial wall 220 of the duct 210. Furthermore, the vanes 310 define a vane cross-sectional area oriented parallel to the central axis 100 and substantially normal to the radial center line 250 of the radial sectors of the duct 210. As in the embodiment discussed above with respect to FIG. 4, the vane cross-sectional area is configured to increase in relation to a radial distance from the central axis 100 such that the overall duct 210 cross-sectional area decreases in relation to the radial distance outward from the central axis 100 and such that the vanes 310 define at least two radial sectors (three, in the embodiment shown in FIG. 5) within the duct 210. As discussed above, the vane 310 cross-sectional area is configured to generally increase in relation to the radial distance from the central axis 100 such that the sides of the vane 310 are oriented at a vane angle from a radius extending from the central axis. Furthermore, the vane 310 may be further configured such that the vane angle increases from the inner radial wall 220 to the outer radial wall 230 of the duct 210. According to various embodiments of the present invention, the vane angle may have various angular values suitable for reducing the overall cross-sectional area of the duct 210 in the radially outward direction, including, for instance less than about 15 degrees, less than about 10 degrees, less than about 5 degrees, and/or other angular values suitable for substantially balancing the centrifugal force 160 and the drag force 170 exerted on a component 150 suspended radially within the duct 210 as it is rotated about the central axis 100.

In the system embodiment shown in FIG. 5 the vane cross-sectional area is configured to sharply decrease such that the vanes 310 define three component braking zones 225 defined radially inward from the radial sectors of the duct 210. As discussed above, the component braking zones 225 may be defined by, in some instances, a pair of side walls flaring outward from a line that is substantially parallel to the radial center line 250 of the duct 210 such that the cross-sectional area encompassed by the component braking zone 225 is greatly increased from the innermost radial end of the duct 210 (or the a radial sector defined therein by one or more vanes 310). Furthermore, in relation to equation (4) the overall velocity of the flow of fluid in the chamber 200 generally slows as the cross-sectional area of the chamber 200, duct 210, or radial sector widens. The component braking zone 225 defined, for instance, at the innermost radial end of the duct 210 may thus prevent accidental wash-out of the components 150 suspended therein as elutriation fluid is forced through the duct 210 from the elutriation inlet 203 to the elutriation outlet 205.

In addition, the system embodiment shown in FIG. 5 also comprises a filter device 450 disposed radially inward of the component braking zones 225. The filter device may be configured to catch contaminants or small particulate components of the fluid that are washed radially inward through the duct 210 by a supply of elutriation fluid flowing, or instance, from an elutriation inlet 205 (see FIG. 3), through the duct 210, and radially inward towards an elutriation outlet 203 (see FIG. 3). In such cases the filter device 450 may define sized pores configured to maintain the position of selected components 150 within the radial length 215 of the duct 250 even in cases wherein the flow of elutriation fluid (through an elutriation inlet 205, for instance) is powerful enough to push the selected components through the component braking zone 225 defined by the vanes 310 and/or an inner wall of the chamber 200. In addition, in some embodiments, the filter device 450 may contain selective binding elements suitable for binding one or more contaminants of interest that may be present in the fluid and/or adhered to the selected components 150 such that the contaminants of interest may be washed through the filter during an elutriation cycle. Thus, the filter device 450 may selectively remove harmful contaminants from the elutriation fluid so that it may be recycled in some cases.

According to the system embodiment shown in FIG. 5, the radial sectors defined by the vanes 310 in the duct 210 may also include side inlets and/or outlets 480 wherein the side inlets and outlets may be defined in the vanes 310 and/or in an inner wall of the chamber 200. In some embodiments, the side inlets 480 may be used to inject a fractional flow of elutriation fluid in the circumferential direction (normal to the radially inward direction of the main supply of elutriation fluid (supplied, for instance, by an elutriation inlet 205 as shown in FIG. 3)). The side inlets may be configured to provide a fractional elutriation flow that is, in some instances about 10% of the velocity of the main radial flow of elutriation fluid. This fractional (side) flow may act to balance the slight angular component of advancing radial flow field that is introduced by the slight angle of the side walls 240 and/or vanes 310 of the duct 210. Without the addition of the fractional side flow component (through the side inlets 480), the components 150 suspended in the radial length 215 of the duct 210 would tend to flow towards the side wall 240 of the duct (or towards the vanes 310) during equilibrium operation of the system. It is important to note, however, that in embodiments of the present invention (wherein the side wall angle 301 (see FIG. 3)) is less than about 6 degrees, the angular component of the flow field is approximately 10%.

Thus, according to some embodiments, the system shown in FIG. 5 may also comprise side outlets 480 such that the slight angular component of the velocity of the components (towards the side walls 240 and/or vanes 310) may be utilized to collect the components 150 from the duct 210. For instance, after elutriation, fractionation, and/or other centrifugation steps are complete, the remaining components 150 may be drawn out from the duct 210 through the side outlets 480.

Also, as shown in the system embodiment of FIG. 5, a conventional elutriation inlet 205 as described above, may be replaced with a bulb inlet 460 wherein elutriation fluid may be introduced via a central elutriation inlet 461 comprising an inlet tube located in the in the center of the bulb inlet 460. Such a bulb inlet 460 arrangement may allow for the removal of selected components 150 through a path (such as through an elutriation inlet or bulb inlet 460) that is free of the contaminants that may be washed out during an elutriation process.

To achieve these results, the fluid (and components 150 suspended therein) are introduced into the chamber 200 at an elutriation outlet 203 located radially inward of the duct 210. (Note that in some embodiments, the filter device 450 may be omitted if the fluid and suspended components 150 are introduced to the chamber 200 radially inward from the inner radial wall 220 of the duct 210.) The components 150 are allowed to settle in the duct 210 before starting the elutriation fluid flow. Once initiated, the largest components 150 (notably the monocytes, etc.) may progress radially outward through the duct 210 and eventually to the entrance of the bulb inlet 460. At this point, the cross sectional area of the bulb inlet 460 opens widely (as shown in FIG. 5), which decreases the elutriation fluid velocity. Thus large leukocytes may then progress rapidly to the radially outward end of the bulb geometry, where they collect and are held in place by centrifugal force 160. Conversely, the smaller components are trapped in the radial length 215 of the duct 210 and thus never penetrate the bulb inlet 460 so long as the elutriation fluid is flowing radially inward through the bulb inlet 460.

One advantage of this approach is highly effective leukoreduction (removal of white blood cells. Another advantage is that the inlet tube 461 for the elutriation fluid is in the center of the bulb inlet 460, where it cannot be blocked by the relatively large leukocytes. Conversely, conventional elutriation systems typically “chug” due to successive blockages by leukocytes wherein the leukocytes temporarily block an inlet by the centrifugal force 160 acting on their relatively large mass. In addition, one skilled in the art will appreciate that the bulb inlet 460 may provide a quite uniform entry flow field for the supply of elutriation fluid as it enters the duct 210 and the rest of the chamber 200.

Additionally, in the bulb inlet 460 embodiment, after the elutriation step is complete, the supply of elutriation fluid may be turned off, and a valve 470 (in fluid communication with the bulb inlet 460) may be opened to allow fluid communication with a collection bag 465a. This bag 465a is constrained to hold only a specified amount of fluid, specifically the approximate volume of the bulb inlet 460. As a result, all of the cells are collected rapidly, with no pump damage or sophisticated controls.

Once the elutriation fluid flow is stopped, the other components 150 in the duct 210 then proceed into the bulb inlet 460. When the components 150 are completely packed against the radially outer wall of the bulb geometry, a second valve 470 is opened to a second bag 465b thus yielding the selected components 150 without the need for a separate centrifuge step.

Thus, using this bulb inlet embodiment, only cleaned components 150 (that have been washed with elutriation fluid) are collected, and there is thus no risk of re-contamination —since the cleaned components 150 pass out through the bulb inlet 460 that have not been contaminated by the passage of pathogens or other contaminants (which are washed radially inward by the flow of elutriation fluid). Conversely, in conventional elutriation systems, the processed cells must pass out through the same exit that was used to remove the contaminants.

In addition, some embodiments of the present invention may further comprise one or more ultrasound transducers operably engaged with the duct 210 so as to be capable of introducing sound waves into the fluid. Such transducers may comprise, for instance, piezoelectric wafers that may be operably engaged with the outer radial wall 230 (or other surface) of the duct 210 so as to be capable of applying ultrasonic energy to the fluid flow contained within the duct 210 and/or chamber 200. In addition, the transducers may be remotely connected to their electrical and/or control sources such that such sources need not affect the balance and or load on the chamber 200 which rotates about the central axis 100 of the centrifuge device 400. To achieve the benefits of ultrasound described below in practice, it is necessary to apply ultrasound to the fluid passages (duct 210 and/or chamber 200) described above. Ultrasound generally refers to sonic waves beyond the limit of human hearing, which is about 20 kHz. For embodiments of the present invention utilizing ultrasound transducers, ultrasound in the range of 20 to 100 kHz is preferred, and more specifically, sound in the range of 40 to 60 kHz is preferred. This range spans the currently available “power” ultrasound sources, and as higher frequency sources become cheaper and more widely available, such sources may be used as well.

In general, ultrasound systems consist of a power source, a high frequency electrical pulse generator, an amplifier for these pulses, connecting cable, and a transducer (such as a piezoelectric wafer) to convert these pulses to sound waves. The transducer assembly in turn consists of piezoelectric crystals that expand and contract in response to the electrical pulses, as well as some type of coupling, or horn, to transmit the pressure pulses from the moving crystal to the load to be treated.

Because it is necessary to minimize the rotating mass, the power source, pulse generator, and amplifier are all kept fixed and outside the rotating mass of the chamber 200 and duct 210. The output from the amplifier is then fed to the rotating centrifuge shaft, where it is connected across sliding contacts to a line on the rotor of the centrifuge device 400, preferably as near to the central axis 100 as possible to minimize wear. This line is then connected to the piezoelectric crystals, which are embedded in the chamber 200 that contains the above duct 210 assembly. For maximum effectiveness, the ultrasound sources are placed radially outward from the duct 210, so that the centrifugal force 160 provides tight coupling.

To control the system, an ultrasonic power meter is installed on the load, with the signal coupled by the same technique used to connect the power line. For cellular processing, it is particularly important to avoid cavitation, which occurs when the low pressure part of the sound wave falls below the vapor pressure of the liquid. The resulting gas bubble formation is so strong that it rapidly ruptures cells. To avoid this phenomenon, the system must be monitored for a sharp “frying” or “cracking” sound, which is well-known in the discipline to indicate the onset of cavitation. With this control, the system can be adjusted as necessary to achieve the benefits described below.

The application of ultrasound energy in these embodiments may have many advantages. For instance, ultrasound pulses may act to decrease the effective viscosity of the liquid, thereby increasing the terminal velocity (allowing for increased elutriation flow in the duct 210, more effective elutriation, and faster collection times for the selected components 150). Ultrasound also reduces the fluid boundary layer around the components 150, thereby decreasing their effective cross sectional area.

In addition, the addition of ultrasound energy to the duct 210 promotes plug flow within the duct 210. One skilled in the art will appreciate that plug flow is desirable for uniform elutriation of the components 150. Ultrasound aids plug flow by decreasing the viscosity and by virtually eliminating the boundary layers near the walls. Current measurements show that ultrasound in the hundred kHz region has a boundary layer smaller than a single red cell.

Ultrasound may also beneficially increase the reactivity of decontamination agents, such as ozone. Part of the increase is due to improving mixing and/or diffusion of ozone within the flow field of the duct 210 by promoting the breakdown of boundary layers near the periphery of individual components 150 (to which, may be adhered contaminants). At sufficiently high sound levels, the underlying reactions themselves are accelerated, but such intensities can also damage certain components 150.

The application of ultrasonic energy may also aid in the effectiveness of another embodiment of the present invention wherein various “forms” of platelets are separated. More specifically, one skilled in the art will appreciate that platelets exist in either two forms in the body: resting or activated. The “resting” platelets flow freely in the circulation. They exist as slightly flattened discs. To participate in the clotting process, however, the platelets must become “activated.” During the activation process, the platelets become essentially spherical, with protruding branches. Conventional elutriation and/or centrifugation devices provide no effective technique to separate the two types of platelets.

Ultrasound embodiments of the present invention achieve such a platelet separation. For instance, to achieve such a separation, the chamber 200 and duct 210 of the present invention is run in “reverse” mode, such that the platelets exiting the duct 210 at the radially outer end of the duct 210 (i.e., through the elutriation inlet 205). Ultrasound is applied normal to the duct radial centerline 250 (i.e., from the side walls 240 of the duct 210). Platelets emerging from the duct 210 consist of a mixture of activated spheres, and platelets normal to the centerline due to acoustic radiation force and torque. The resting platelets are thus in the position of maximum drag. The platelets are then passed to a time of flight selector, with ultrasound applied along the radial direction. The resting platelets are thus in the position of minimum drag, and the resulting decrease in effective cross section thus provides the desired separation.

Also as shown in FIG. 5 the centrifuge device 400 may be balanced by a movable counterbalance, such as, for instance counterweights 420 configured to be capable of advancing and/or retracting radially on a threaded rod 410 oriented so as to dynamically balance the chamber 200, duct 210, and fluids moving therein. Under this arrangement, imbalances may be sensed by vibration, torque, or optical means. One skilled in the art will appreciate that the counterweights 420 may then be moved either radially outward or radially inward as necessary to substantially balance the rotating system. The centrifuge device 400 may also be balanced by a number of other centrifuge balancing methods that will be appreciated by one skilled in the art, including, for instance, chambers 200 suspended on tilt mechanisms such that the chamber 200 is tilted up and radially outward by centrifugal force when the centrifuge device 400 is rotating.

According to some embodiments of the present invention, the centrifuge device 400 may be further balanced by the movement of various fluids about the centrifuge device so as to counteract the movement of elutriation fluid and biological fluids (such as blood) radially inward and outward through the chamber 200 and duct 210 of the present invention. In some embodiments of the system embodiments of the present invention, and in order to avoid the cost and complexity of feeding the elutriation materials through the central axis 100 of the centrifuge device 400, the supply of elutriation fluid will be provided in bags on the rotor (housing the chamber 200 and duct 210) itself. It will therefore be necessary to pump the fluids by some type of driver device on the rotor (such as a variable speed pump, or other device suitable for directing the supply of elutriation fluid through the elutriation inlet 205 or through side inlets 460 defined in the side walls 240 and/or vanes 310 of the duct 210). In some embodiments, a sterile filter device may be provided in fluid communication between the elutriation fluid source and the inlet 205. According to one embodiment, the system of the present invention may comprise a small electric pump, with either wireless or axially mounted controls.

To prevent the fluid reservoir bags (described above) from causing an imbalance, a ballast arrangement may also be used wherein each bag may be contained in a sealed bucket, with access only through the top to contain any leaks. Each bag will consist of a sealed container with a ribbed tube extending from the top of the bag to the bottom of the bag. The tube will be open only at the bottom of the bag. The ribs will allow for the fluid to form a column along the tube length. For example, the supply of elutriation fluid will start in one such bag. The fluid will progress from this bag and through the chamber 200, which is already filled with fluid (such as saline and/or the fluid in which the component 150 is suspended). As a result, as the supply of elutriation fluid leaves the first bag, additional fluid returns to a matching bag. This process continues until all of the fluid is transferred from one bag to the other matching bag. Under this approach, the system remains in balance, with no net change in mass or mass location. Note that the matching bags will be stacked horizontally on top of each other to minimize any torque about the axis; furthermore, the bags may be placed in swinging centrifuge buckets in order to compensate for any slight imbalances.

In other embodiments, these matching bags will be placed in specially designed buckets that will hold only a pre-set volume of fluid. For example, the duct 210 of the chamber 200 could be designed to hold 3 cm of fluid. To collect the components 150 suspended in such a duct 210 without including excess fluid from the rest of the chamber, the receiving bag would also be designed to hold only 3 cm of fluid, which would be available only while pumping 3 cm of ballast fluid into the radially-outward end of the elutriation chamber (i.e., through the elutriation inlet 205). This fixed volume approach will thus allow the collection only the desired amount of fluid, without expensive scales or other measurement techniques, thereby decreasing overall costs. In addition, pumping only the ballast fluid prevents any pump damage to the components 150, which, as one skilled in the art will appreciate, can be significant for high component 150 concentrations.

FIGS. 2-5 also illustrate a method for separating at least one component 150 from a fluid. In one embodiment, shown generally in FIG. 5, the method comprises rotating the fluid and the at least one component 150 disposed therein in a chamber 200 about a central axis 100 of a centrifuge device 400 and directing the fluid and the least one component 150 disposed therein through at least one radially-extending duct 210 disposed within the chamber 200. As discussed above, with respect to the chamber and system embodiments of the present invention, the duct 210 defines a duct cross-sectional area oriented parallel to the central axis 100 wherein the duct cross-sectional area is configured to decrease in relation to a radial distance from the central axis 100 such that a centrifugal force 160 exerted on the at least one component 150 of the fluid by the chamber 200 rotating about the central axis 100 of the centrifuge device 400 substantially opposes a drag force 170 exerted on the at least one component 150 by the fluid along the radial length 215 of the duct 210.

According to other embodiments of the present invention, as shown generally in FIGS. 2 and 3 the method may further comprise directing a supply of elutriation fluid radially inward (via an elutriation inlet 203, for instance) through the duct 210 in a substantially uniform radial flow so as to wash a plurality of contaminants out of the fluid and away from the at least one component 150 disposed therein. Other method embodiments may further comprise: passing the elutriation fluid through at least one device (such as a flow straightening screen, baffles, or other flow straightening device) configured to direct the supply of elutriation fluid radially inward through the duct 210 in a substantially uniform radial flow, filtering the plurality of contaminants from the elutriation fluid using a filter device 450 (see FIG. 5) disposed radially inward from the duct 210, and/or collecting the elutriation fluid and the plurality of contaminants in a collection reservoir (not shown) in fluid communication with an elutriation outlet 205 (see FIGS. 2 and 3) defined by an inner radial wall 220 of the duct 210.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A chamber for separating at least one component from a fluid, the chamber adapted to be capable of rotating about a central axis of a centrifuge device, the chamber further adapted to be capable of containing the fluid and the at least one component disposed therein, the chamber comprising at least one radially-extending duct defining a duct cross-sectional area oriented substantially parallel to the central axis, the duct cross-sectional area being configured to decrease in relation to a radial distance from the central axis such that a centrifugal force exerted on the at least one component of the fluid by the chamber rotating about the central axis of the centrifuge device substantially opposes a drag force exerted on the at least one component by the fluid along a length of the duct.

2. A chamber according to claim 1, wherein the at least one duct further comprises:
an upper wall extending radially outward from the central axis; and
a lower wall extending radially outward from the central axis;
the upper wall and the lower wall being formed so as to form a convergent profile about a plane of rotation defined by a radius extending radially outward from the central axis.

3. A chamber according to claim 1, wherein the duct extends radially outward 360 degrees about the central axis.

4. A chamber according to claim 2, wherein the fluid comprises a plurality of components having a corresponding plurality of sizes, including a minimum size and a maximum size, and wherein the duct further comprises:
an entrance, defining an entrance area between the upper and lower walls, disposed at a first radial distance from the central axis, the entrance area being configured such that a centrifugal force exerted on a component having the maximum size substantially opposes a drag force exerted on the component having the maximum size at the first radial distance, such that the component having the maximum size is substantially suspended at the first radial distance;
an exit, defining an exit area between the upper and lower walls, disposed at a second radial distance from the central axis, the exit area configured such that a centrifugal force exerted on a component having the minimum size substantially opposes a drag force exerted on the component having the minimum size at the second radial distance, such that the component having the minimum size is substantially suspended at the second radial distance; and
wherein the convergent profile formed by the upper wall and the lower wall is configured such that the plurality of components having sizes between the minimum and maximum size exhibit a substantially uniform distribution between the first and second radial distances.

5. A chamber according to claim 4, wherein the substantially uniform distribution comprises a substantially uniform number of the plurality of components per a unit volume of the duct between the first and second radial distances.

6. A chamber according to claim 4, wherein the convergent profile formed between the upper and lower walls is configured to converge in relation to a radial distance from the central axis and a square of the plurality of sizes.

7. A chamber according to claim 4, wherein the fluid comprises plasma and wherein the plurality of components comprises a plurality of red blood cells having a maximum size of about 8 microns and a minimum size of a about 7 microns, and wherein the convergent profile is formed to suspend, between the first and second radial distances, the plurality of components having a ratio of maximum size to minimum size selected from a group consisting of:
between about 1 and 1.5 to 1;
between about 1 and 1.3 to 1; and
between about 1 and 1.05 to 1.

8. A chamber according to claim 4 wherein the fluid comprises plasma and wherein the plurality of components comprises a plurality of platelets having a maximum size of about 4 microns and a minimum size of about 2 microns, and wherein the convergent profile is formed to suspend, between the first and second radial distances, the plurality of components having a ratio of maximum size to minimum size selected from a group consisting of:
between about 1.5 and 3 to 1;
between about 1.75 and 2.5 to 1; and
between about 2 and 2.25 to 1.

9. A chamber according to claim 4 wherein the fluid comprises plasma and wherein the plurality of components comprises a plurality of monocytes having a maximum size of about 20 microns and a minimum size of about 10 microns, and wherein the convergent profile is formed to suspend, between the first and second radial distances, the plurality of components having a ratio of maximum size to minimum size selected from a group consisting of:
between about 1.5 and 3 to 1;
between about 1.75 and 2.5 to 1; and
between about 2 and 2.25 to 1.

10. A chamber according to claim 1, wherein the duct comprises a cross-sectional shape chosen from a group consisting of:
rectangles;
ovals;
circles;
polygons; and
combinations thereof.

11. A chamber according to claim 1, wherein the at least one duct further comprises a pair of side walls.

12. A chamber according to claim 11, wherein each of the pair of side walls extends radially outward from the central axis such that the duct defines a radial sector.

13. A chamber according to claim 11, wherein the pair of side walls are disposed at a side wall angle relative to a radius extending radially outward from the central axis such that the duct cross-sectional area is configured to decrease in relation to the radial distance from the central axis.

14. A chamber according to claim 13, wherein the side wall angle has a value selected from a group consisting of:
less than about 45 degrees;
less than about 30 degrees;
less than about 15 degrees;
less than about 10 degrees; and
less than about 5 degrees.

15. A chamber according to claim 1, wherein the at least one duct further comprises:
an inner radial wall proximal to the central axis;
an outer radial wall disposed substantially parallel to and radially outward from the inner radial wall.

16. A chamber according to claim 11, wherein the at least one duct further comprises:
an upper wall substantially perpendicular to the central axis; and
a lower wall substantially perpendicular to the central axis.

17. A chamber according to claim 15, wherein the at least one duct further comprises at least one vane extending radially inward from the outer radial wall to the inner radial wall, the at least one vane defining a vane cross-sectional area oriented parallel to the central axis, the vane cross-sectional area being configured to increase in relation to a radial distance from the central axis such that the duct cross-sectional area decreases in relation to the radial distance from the central axis and such that the vane defines at least two radial sectors within the duct.

18. A chamber according to claim 17, wherein the at least one vane defines at least one channel, the at least one channel configured to allow fluid communication between the at least two radial sectors.

19. A chamber according to claim 17, wherein the vane cross-sectional area of the at least one vane is configured to increase in relation to the radial distance from the central axis.

20. A chamber according to claim 17, wherein the vane cross-sectional area of the at least one vane is configured to increase linearly in relation to the radial distance from the central axis such that the sides of the at least one vane are oriented at a vane angle from a radius extending from the central axis, the at least one vane being further configured such that the vane angle increases from the inner radial wall to the outer radial wall.

21. A chamber according to claim 20, wherein the vane angle has a value selected from a group consisting of:
less than about 15 degrees;
less than about 10 degrees; and
less than about 5 degrees.

22. A chamber according to claim 15, wherein the outer radial wall defines at least one elutriation inlet, the at least one elutriation inlet configured to allow fluid communication between the duct and a supply of elutriating fluid, the at least one elutriation inlet being further configured to direct the supply of elutriating fluid radially inward through the duct in a substantially uniform radial flow.

23. A chamber according to claim 22, wherein the at least one elutriation inlet further comprises at least one device configured to direct the supply of elutriating fluid radially inward through the duct in a substantially uniform radial flow, the at least one device selected from a group consisting of:
multiple orifices;
baffles;
screens; and
combinations thereof.

24. A chamber according to claim 15, wherein the inner radial wall defines at least one elutriation outlet, the at least one elutriation outlet configured to allow fluid communication between the duct and a collection receptacle, the at least one elutriation outlet being further configured to direct the supply of elutriating fluid radially inward through the duct in a substantially uniform radial flow.

25. A chamber according to claim 24, wherein the at least one elutriation outlet further comprises at least one device configured to direct the supply of elutriating fluid radially inward through the duct in a substantially uniform radial flow, the at least one device selected from a group consisting of:
multiple orifices;
baffles;
screens; and
combinations thereof.

26. A chamber according to claim 1, further comprising a component braking zone defined by a radially-inner wall of the chamber, the component braking zone having a braking zone cross-sectional area that is greater than the duct-cross sectional area, the component braking zone disposed radially inward from the duct so as to prevent the at least one component from advancing radially inward beyond the duct.

27. A chamber according to claim 26, wherein the chamber further defines at least one collection outlet in the component braking zone, the collection outlet adapted to be operably engaged with a collection device for selectively removing the at least one component from the component braking zone.

28. A chamber according to claim 1, further comprising a filter device operably engaged with a radially-inner wall of the chamber, the filter device disposed radially inward from the duct so as to prevent the at least one component from advancing radially inward beyond the duct.

29. A chamber according to claim 1, wherein the duct is composed of a material that is transparent to ultraviolet-C light energy.

30. A chamber according to claim 1, wherein the duct is composed of a material selected from a group consisting of:
fused quartz;
PTFE;
rigid polymer materials;
metallic alloys; and
combinations thereof.

31. A chamber according to claim 1, wherein the duct is composed of a sterile disposable material such that the duct may be replaced following a single use of the chamber.

32. A chamber according to claim 1, further comprising an ultrasound device operably engaged with the chamber, the ultrasound device configured to be capable of emitting an ultrasound signal into the chamber.

33. A chamber according to claim 32, wherein the ultrasound device comprises:
an ultrasound transducer operably engaged with the chamber; and
a control device configured to be communication with the ultrasound transducer, the control device being further configured to be capable of controlling the ultrasound signal emitted by the ultrasound device.

34. A chamber according to claim 1, wherein the chamber further defines at least one collection outlet adapted to be operably engaged with a collection device for selectively removing the at least one component from the duct.

35. A method for separating at least one component from a fluid, the method comprising:
providing a radially-extending chamber defining a duct adapted to be rotated about a central axis of a centrifuge device, the chamber defining a duct cross-sectional area oriented parallel to the central axis, the duct cross-sectional area being configured to decrease in relation to a radial distance from the central axis;
rotating the radially extending chamber, the fluid, and the at least one component disposed therein about a chamber about the central axis of the centrifuge device such that a centrifugal force exerted on the at least one component of the fluid by the chamber rotating about the central axis of the centrifuge device substantially opposes a drag force exerted on the at least one component by the fluid along a length of the duct.

36. A method according to claim 35, wherein the providing step further comprises:
providing a duct upper wall extending radially outward from the central axis; and
providing a duct lower wall extending radially outward from the central axis;
forming a convergent profile between the duct upper wall and the duct lower wall about a plane of rotation defined by a radius extending radially outward from the central axis.

37. A method according to claim 35, wherein the providing step further comprises providing a duct that extends radially outward 360 degrees about the central axis.

38. A method according to claim 36, wherein the fluid comprises a plurality of components having a corresponding plurality of sizes, including a minimum size and a maximum size, and wherein the providing step further comprises:
providing a duct entrance defining an entrance area between the duct upper and lower walls, disposed at a first radial distance from the central axis, the entrance area being configured such that a centrifugal force exerted on a component having the maximum size substantially opposes a drag force exerted on the component having the maximum size at the first radial distance, such that the component having the maximum size is substantially suspended at the first radial distance;
providing a duct exit, defining an exit area between the duct upper and lower walls, disposed at a second radial distance from the central axis, the exit area configured such that a centrifugal force exerted on a component having the minimum size substantially opposes a drag force exerted on the component having the minimum size at second radial distance, such that the component having the minimum size is substantially suspended at the second radial distance; and wherein the forming step further comprises:
forming the convergent profile between the duct upper wall and the duct lower wall such that the plurality of components having sizes between the minimum and maximum size exhibit a substantially uniform distribution between the first and second radial distances.

39. A method according to claim 38, wherein the forming step further comprises forming the convergent profile such that the substantially uniform distribution comprises a substantially uniform number of the plurality of components per a unit volume of the duct between the first and second radial distances.

40. A method according to claim 38, wherein the forming step further comprises forming the convergent profile between the upper and lower walls in relation to a radial distance from the central axis and a square of the plurality of sizes.

41. A method according to claim 38, wherein the fluid comprises plasma and wherein the plurality of components comprises a plurality of red blood cells having a maximum size of about 8 microns and a minimum size of about 7 microns, and wherein the forming the convergent profile step further comprises forming a convergent profile to suspend, between the first and second radial distances, the plurality of components having a ratio of maximum size to minimum size selected from a group consisting of:
between about 1 and 1.5 to 1;
between about 1 and 1.3 to 1; and
between about 1 and 1.05 to 1.

42. A method according to claim 38 wherein the fluid comprises plasma and wherein the plurality of components comprises a plurality of platelets having a maximum size of about 4 microns and a minimum size of about 2 microns, and wherein the forming the convergent profile step further comprises forming a convergent profile to suspend, between the first and second radial distances, the plurality of components having a ratio of maximum size to minimum size selected from a group consisting of:
between about 1.5 and 3 to 1;
between about 1.75 and 2.5 to 1; and
between about 2 and 2.25 to 1.

43. A method according to claim 38 wherein the fluid comprises plasma and wherein the plurality of components comprises a plurality of monocytes having a maximum size of about 20 microns and a minimum size of about 10 microns, and wherein the forming the convergent profile step further comprises forming a convergent profile to suspend, between the first and second radial distances, the plurality of components having a ratio of maximum size to minimum size selected from a group consisting of:
between about 1.5 and 3 to 1;
between about 1.75 and 2.5 to 1; and
between about 2 and 2.25 to 1.

44. A method according to claim 35, further comprising directing a supply of elutriation fluid radially inward through the duct in a substantially uniform radial flow so as to wash a plurality of contaminants out of the fluid and away from the at least one component disposed therein.

45. A method according to claim 44, further comprising passing the elutriation fluid through at least one device configured to direct the supply of elutriation fluid radially inward through the duct in a substantially uniform radial flow.

46. A method according to claim 44, further comprising filtering the plurality of contaminants from the elutriation fluid using a filter device disposed radially inward from the duct.

47. A method according to claim 44, further comprising collecting the elutriation fluid and the plurality of contaminants in a collection reservoir in fluid communication with an elutriation outlet defined by a inner radial wall of the at least one duct.

48. A method according to claim 35, further comprising emitting an ultrasound signal into the chamber from an ultrasound device operably engaged with the chamber.

49. A method according to claim 35, further comprising collecting the at least one component from a component braking zone defined by a radially-inner wall of the chamber, the component braking zone having a braking zone cross-sectional area that is greater than the duct-cross sectional area, and the component braking zone being disposed radially inward from the duct so as to prevent the at least one component from advancing radially inward beyond the duct.

50. A method according to claim 35, further comprising:
defining at least one collection outlet in the chamber;
operably engaging the at least one collection outlet with a collection device; and
selectively removing the at least one component from the duct using the collection device.

51. A method for constructing a chamber for uniformly distributing a plurality of components having a corresponding plurality of sizes, including a minimum size and a maximum size, in a fluid that is subject to centrifugation, the method comprising:
providing a radially-extending chamber defining a duct adapted to be rotated about a central axis of a centrifuge device;
providing a duct upper wall extending radially outward from the central axis;
providing a duct lower wall extending radially outward from the central axis;
forming a radially-extending convergent profile between the duct upper wall and the duct lower wall about a plane of rotation defined by a radius extending radially outward from the central axis;
providing a duct entrance, defining an entrance area between the upper and lower walls, disposed at a first radial distance from the central axis, the entrance area being configured such that a centrifugal force exerted on a component having the maximum size substantially opposes a drag force exerted on the component having the maximum size at the duct entrance, such that the component having the maximum size is substantially suspended at the first radial distance;
providing a duct exit, defining an exit area between the upper and lower walls, disposed at a second radial distance from the central axis, the exit area being configured such that a centrifugal force exerted on a component having the minimum size substantially opposes a drag force exerted on the component having the minimum size at the duct exit, such that the component having the minimum size is substantially suspended at the second radial distance; and
modifying the convergent profile between the duct upper wall and the duct lower wall such that the plurality of components having sizes between the minimum and maximum size exhibit a substantially uniform distribution between the first and second radial distances.

52. A method according to claim 51, wherein the modifying step further comprises determining a plurality of duct areas defined between the upper and lower walls at a plurality of radial distances between the first and second radial distances such that a centrifugal force exerted each of the plurality of components by the chamber rotating about the central axis of the centrifuge device substantially opposes a drag force exerted on each of the plurality of components by the fluid along a length of the duct.

53. A method according to claim 51, wherein the modifying step further comprises
determining a distribution of the plurality of particles per unit volume of the duct by equating a centrifugal force exerted each of the plurality of components by the chamber rotating about the central axis of the centrifuge device with a drag force exerted on each of the plurality of components by the fluid along a length of the duct;
comparing the determined distribution to a substantially uniform distribution of the plurality of components per a unit volume of the duct along the length of the duct to determine a distribution difference;
correcting the convergent profile at least partially based on the distribution difference;
repeating the determining, comparing, and correcting steps such that the substantially uniform distribution comprises a substantially uniform number of the plurality of components per unit volume of the duct between the first and second radial distances.
